(19) United States
(12) Patent Application Publication
(10) Pub. No.: US 2005/0117623 A1
(43) Pub. Date: Jun. 2, 2005

(54) Optoelectronic device incorporating an interference filter

(75) Inventors: Vitaly Shchukin, Berlin (DE); Nikolai Ledentsov, Berlin (DE)

Correspondence Address: BROWN & MICHAELS, PC;400 M & T BANK BUILDING, 118 NORTH TIOGA ST, ITHACA, NY, 14850, US

(73) Assignee: NL-Nanosemiconductor GmbH, Dortmund (DE)

(21) Appl. No.: 11/000,116

(22) Filed: Nov. 30, 2004

Related U.S. Application Data
(60) Provisional application No. 60/526,409, filed on Dec. 1, 2003.
(60) Provisional application No. 60/577,537, filed on Jun. 7, 2004.

(51) Int. Cl. H01S 3/082

(52) U.S. Cl. 372/97; 372/43

(57) ABSTRACT

A novel class of optoelectronic devices incorporate an interference filter. The filter includes at least two optical cavities. Each of the cavities localizes al least one optical mode. The optical modes localized at two cavities are at resonance only at one or at a few discrete selective wavelengths. At resonance, the optical eigenmodes contain one mode having a zero intensity at a node position between the two cavities, where this position shifts as a function of the wavelength. A non-transparent element, which is preferably an absorbing element, a scatterer, or a reflector, is placed between two cavities. At a discrete selective wavelength, when the node of the optical mode matches with the non-transparent element, the filter is transparent for light. At other wavelengths, the filter is not transparent for light. This allows for the construction of various optoelectronic devices showing a strongly wavelength-selective operation.

### REFERENCE TO RELATED APPLICATIONS

This application claims an invention which was disclosed in Provisional Application No. 60/526,409, filed Dec. 1, 2003, entitled “TILTED CAVITY SEMICONDUCTOR LIGHT-EMITTING DEVICE AND METHOD OF MAKING SAME” and Provisional Application No. 60/577,537, filed Jun. 7, 2004, entitled “ELECTROOPTICALLY WAVELENGTH-TUNABLE RESONANT CAVITY OPTOELECTRONIC DEVICE FOR HIGH-SPEED DATA TRANSFER”. The benefit under 35 USC §119(e) of the provisional applications is hereby claimed, and the aforementioned applications are hereby incorporated herein by reference.

### BACKGROUND OF THE INVENTION

1. Field of the Invention

The invention pertains to the field of optoelectronic devices. More particularly, the invention pertains to semiconductor edge-emitting and surface-emitting lasers, optical amplifiers, photodetectors, wavelength-tunable vertical cavity lasers, optical filters, optical switches, wavelength-tunable tilted cavity lasers, wavelength-tunable resonance photodetectors, electrooptical modulators, wavelength division multiplexing systems, and wavelength-selective light sources including wavelength-defined incandescent lamps.

2. Description of Related Art

A prior art optoelectronic device, for example, an edge-emitting laser, is shown in FIG. 1(a). The laser structure (100) is grown epitaxially on an n-doped substrate (101). The structure includes an n-doped cladding layer (102), a waveguide (103), a p-doped cladding layer (108), and a p-contact layer (109). The waveguide (103) includes an n-doped layer (104), a confinement layer (105) with an active region (106) inside the confinement layer, and a p-doped layer (107). The n-contact (111) is contiguous with the substrate (101). A p-contact (112) is mounted on the p-contact layer (109). The active region (106) generates light when a forward bias (113) is applied. The profile of the optical mode in the vertical direction z is determined by the refractive index profile in the z-direction. The waveguide (103) is bounded in the lateral plane by a front facet (116) and a rear facet (117). If a special highly reflecting coating is put on the rear facet (117), the laser light (115) is emitted only through the front facet (116).

The substrate (101) is formed from any III-V semiconductor material or III-V semiconductor alloy. Some examples for the substrate include GaAs, InP, or GaSb. GaAs or InP are preferably used depending on the desired emitted wavelength of laser radiation. Alternatively, sapphire, SiC or [111]-Si is used as a substrate for GaN-based lasers (i.e. laser structures, the layers of which are formed of GaN, AlN, InN, or alloys of these materials). The substrate (101) is doped by an n-type, or donor impurity. Possible donor impurities include, but are not limited to S, Se, Te, and amphoteric impurities like Si, Ge, Sn, where the latter are introduced under such technological conditions that they are incorporated predominantly into the cation sublattice to serve as donor impurities.

The n-doped cladding layer (102) is formed from a material lattice-matched or nearly lattice-matched to the substrate (101), is transparent to the generated light, and is doped by a donor impurity. In the case of a GaAs substrate (101), the n-doped cladding layer is preferably formed of a GaAlAs alloy.

The n-doped layer (104) of the waveguide (103) is formed from a material lattice-matched or nearly lattice-matched to the substrate (101), is transparent to the generated light, and is doped by a donor impurity. For a GaAs substrate, the n-doped layer (104) of the waveguide is preferably formed of GaAs or of a GaAlAs alloy having an Al content lower than that in the n-doped cladding layer (102).

The p-doped layer (107) of the waveguide (103) is formed from a material lattice-matched or nearly lattice-matched to the substrate (101), is transparent to the generated light, and is doped by an acceptor impurity. Preferably, the p-doped layer (107) of the waveguide is formed from the same material as the n-doped layer (104) but doped by an acceptor impurity. Possible acceptor impurities include, but are not limited to, Be, Mg, Zn, Cd, Pb, Mn and amphoteric impurities like Si, Ge, Sn, where the latter are introduced under such technological conditions that they are incorporated predominantly into the anion sublattice and serve as acceptor impurities.

The p-doped cladding layer (108) is formed from a material lattice-matched or nearly lattice-matched to the substrate (101), transparent to the generated light, and doped by an acceptor impurity. Preferably, the p-doped cladding layer (108) is formed from the same material as the n-doped cladding layer (102), but is doped by an acceptor impurity.

The p-contact layer (109) is preferably formed from a material lattice-matched or nearly lattice matched to the substrate, is transparent to the generated light, and is doped by an acceptor impurity. The doping level is preferably higher than that in the p-cladding layer (108).

The metal contacts (111) and (112) are preferably formed from multi-layered metal structures. For example, the metal contact (111) is preferably formed from the structure Ni—Au—Ge and the metal contacts (112) are preferably formed from the structure Ti—Pt—Au.

The confinement layer (105) is formed from a material lattice-matched or nearly lattice-matched to the substrate (101), is transparent to the generated light, and is either undoped or weakly doped. The confinement layers are preferably formed from the same material as the substrate (101).

The active region (106) placed within the confinement layer (105) is preferably formed by any insertion, the energy band gap of which is narrower than that of the substrate (101). Possible active regions (106) include, but are not limited to, a single-layer or a multi-layer system of quantum wells, quantum wires, quantum dots, or any combination thereof. For a device on a GaAs-substrate, examples of the active region (106) include, but are not limited to, a system of insertions of InAs, In₁₋ₓGaₓAs, InₓGa_{1-x-y}Al_{y}As, InₓGa₁₋ₓAs_{1-y}N_{y} or similar materials.

One of the major shortcomings of the edge-emitting laser of the prior art is the variation of the energy band gap with temperature resulting in an undesirable temperature dependence of the wavelength of emitted light, particularly for high output power operation.

FIG. 1(b) shows a prior art surface-emitting laser, or more particularly, a vertical cavity surface-emitting laser (VCSEL) (120). The active region (126) is put into a cavity (123), which is sandwiched between an n-doped bottom mirror (122) and a p-doped top mirror (128). The cavity (123) includes an n-doped layer (124), a confinement layer (125), and a p-doped layer (127). Bragg reflectors each including a periodic sequence of alternating layers having low and high refractive indices are used as the bottom mirror (122) and the top mirror (128). The active region (126) generates light when a forward bias (113) is applied. Light comes out (135) through the optical aperture (132). The wavelength of the emitted laser light from the VCSEL is determined by the length of the cavity (123).

The layers forming the bottom mirror (122) are formed from materials lattice-matched or nearly lattice matched to the substrate (101), are transparent to the generated light, are doped by a donor impurity, and have alternating high and low refractive indices. For a VCSEL grown on a GaAs substrate, alternating layers of GaAs and GaAlAs or layers of GaAlAs having alternating aluminum content preferably form the mirror (122).

The n-doped layer (124) of the cavity (123) is formed from a material lattice-matched or nearly lattice-matched to the substrate (101), is transparent to the generated light, and is doped by a donor impurity.

The p-doped layer (127) of the cavity (123) is formed from a material lattice-matched or nearly lattice-matched to the substrate (101), is transparent to the generated light, and is doped by an acceptor impurity.

The layers forming the top mirror (128) are formed from materials lattice-matched or nearly lattice-matched to the substrate (101), are transparent to the generated light, are doped by an acceptor impurity, and have alternating high and low refractive indices. For a VCSEL grown on a GaAs substrate, alternating layers of GaAs and GaAlAs or layers of GaAlAs having alternating aluminum content preferably form the mirror (128).

The p-contact layer (129) is formed from a material doped by an acceptor impurity. For a VCSEL grown on a GaAs substrate, the preferred material is GaAs. The doping level is preferably higher than that in the top mirror (128). The p-contact layer (129) and the metal p-contact (112) are etched to form an optical aperture (132).

The confinement layer (125) is formed from a material lattice-matched or nearly lattice-matched to the substrate (101), is transparent to the generated light, and is either undoped or weakly doped. The confinement layers are preferably formed from the same material as the substrate (101).

The active region (126) placed within the confinement layer (125) is preferably formed by any insertion, the energy band gap of which is narrower than that of the substrate (101). Possible active regions (126) include, but are not limited to, a single-layer or a multi-layer system of quantum wells, quantum wires, quantum dots, or any combination thereof. For a device on a GaAs-substrate, examples of the active region (126) include, but are not limited to, a system of insertions of InAs, In₁₋ₓGaₓAs, InₓGa_{1-x-y}Al_{y}As, InₓGa₁₋ₓAs_{1-y}N_{y} or similar materials.

The active region (126) generates optical gain when a forward bias (113) is applied. The active region (126) then emits light, which is bounced between the bottom mirror (122) and the top mirror (128). The mirrors have high reflectivity for light propagating in the normal direction to the p-n junction plane, and the reflectivity of the bottom mirror (122) is higher than that of the top mirror (128). Thus, the VCSEL design provides a positive feedback for light propagating in the vertical direction and finally results in lasing. The laser light (135) comes out through the optical aperture (132).

One of the major advantages of a VCSEL is the temperature stabilization of the wavelength if the device operates in a single transverse mode. Temperature variations of the wavelength follow the temperature variations of the refractive index, which are an order of magnitude smaller than the variations of the semiconductor band gap energy. A severe disadvantage of a VCSEL, however, is that its output power is limited to a few milliwatts, because it is not possible to provide efficient heat dissipation in the VCSEL geometry keeping a single transverse mode operation.

### SUMMARY OF THE INVENTION

A novel class of optoelectronic devices incorporating an interference filter is disclosed. The filter includes at least two optical cavities, each of which is surrounded by reflectors. Each of the cavities alone localizes at least one optical mode, where the optical mode decays away from the cavity. The two cavities differ in the average refractive index and/or width such that the effective angle of propagation of the optical mode localized by the first cavity as a function of the wavelength follows a first dispersion law, and the effective angle of propagation of the optical mode localized by the second cavity as a function of the wavelength obeys a second dispersion law. In one embodiment, the two dispersion laws match only at one discrete selective wavelength of light and at a selective angle of propagation. At the selective wavelength, the two cavities are at resonance, and the optical eigenmodes of the system are linear combinations of the optical modes localized at individual cavities. One of the optical eigenmodes has a zero intensity at a node positioned between the first cavity and the second cavity. The position of the node shifts as a function of the wavelength.

A non-transparent element is placed between the first cavity and the second cavity in a position that coincides with the node of the optical mode at one selective wavelength or at a few discrete selective wavelengths. At these selective wavelengths, the system is transparent for light in this resonance optical mode. The system is not transparent for light in the rest of the optical modes. At the rest of the wavelengths, other than the selective wavelengths, the system is not transparent for all optical modes.

If a few modes are localized in at least at one of the cavities, e.g., at the first cavity, there may be a few selective wavelengths and selective angles, where matching conditions are met between the optical mode localized at the second cavity and, in turn, with the first, second, etc. modes localized at the first cavity.

In some embodiments, the non-transparent element is an absorbing element, and the optical modes out of resonance exhibit high absorption losses. In other embodiments, the non-transparent element is a scatterer, and the optical modes out of resonance exhibit high losses due to scattering. In both of these groups of embodiments, the low losses are preferably smaller than any of the high losses by at least a factor of five. In other embodiments, the non-transparent element is a reflector, and light in the optical modes out of resonance is not transmitted through the system.

The interference filter of the present invention can be incorporated into a large variety of optoelectronic devices, including semiconductor diode lasers, optical amplifiers, resonant cavity photodetectors, wavelength-tunable lasers, amplifiers, and resonant photodetectors. The interference filter can also be incorporated into intensity-modulated diode lasers. Incorporation of the interference filter into an optoelectronic device results in wavelength-selective operation of the optoelectronic device.

### BRIEF DESCRIPTION OF THE DRAWINGS

FIG. 1(a) shows a schematic diagram of the prior art of a conventional edge-emitting laser.

FIG. 1(b) shows a schematic diagram of the prior art of a conventional vertical cavity surface-emitting laser with doped mirrors.

FIG. 2(a) shows the reflectivity spectra of a multilayered periodic structure at a 65° angle of incidence following A. Yariv and P. Yeh, Optical Waves in Crystals. Propagation and Control of Laser Radiation (Wiley 1984).

FIG. 2(b) shows the reflectivity spectra of a multilayered periodic structure at a 55° angle of incidence.

FIG. 2(c) shows the reflectivity spectra of a multilayered periodic structure at a 40° angle of incidence.

FIG. 2(d) shows the reflectivity spectra of a multilayered periodic structure at a 0° angle of incidence.

FIG. 3 shows a schematic diagram of a tilted cavity laser disclosed in U.S. patent application Ser. No. 10/074,493, filed Feb. 12, 2002, by the inventors of the present invention.

FIG. 4(a) shows a schematic diagram of a cavity sandwiched between two evanescent reflectors in an embodiment of the present invention.

FIG. 4(b) shows a schematic diagram of another cavity sandwiched between two evanescent reflectors in an embodiment of the present invention.

FIG. 4(c) shows a schematic diagram of a structure including two resonantly coupled cavities, sandwiched between evanescent reflectors in an embodiment of the present invention.

FIG. 5(a) shows a schematic diagram of a structure including two coupled cavities and two optical modes extended over both cavities in an embodiment of the present invention.

FIG. 5(b) shows a schematic diagram of a structure including two coupled cavities and two optical modes extended over both cavities exactly at resonance in an embodiment of the present invention.

FIG. 5(c) shows a schematic diagram of a structure including two coupled cavities and two optical modes extended over both cavities, where the wavelength is slightly off resonance, in an embodiment of the present invention.

FIG. 6(a) shows schematically the position of the node of the optical mode having a node as a function of the wavelength of light.

FIG. 6(b) shows schematically the aluminum composition profile for the structure having two coupled cavities, repeating the profile of FIGS. 5(a) through (c).

FIG. 7 shows a schematic diagram of a tilted cavity laser according to an embodiment of the present invention.

FIG. 8 shows a schematic diagram of a tilted cavity laser according to an embodiment of the present invention.

FIG. 9 shows a schematic diagram of a tilted cavity laser according to an embodiment of the present invention.

FIG. 10(a) shows a first optical mode extended over three cavities, where this mode has a large electric field strength in the middle cavity, i.e., at the absorbing element.

FIG. 10(b) shows schematically the same structure as FIG. 10(a), with the second optical mode extended over three cavities, where this mode has a small, nearly vanishing electric field strength in the middle cavity, i.e. at the absorbing element.

FIG. 10(c) shows schematically the same structure as FIG. 10(a), with the third optical mode extended over three cavities, where this mode has a large electric field strength in the middle cavity, i.e., at the absorbing element.

FIG. 11(a) shows the optical mode at a wavelength of light of 809 nm, where the electric field strength in the middle cavity has a significant value.

FIG. 11(b) shows schematically the same structure as FIG. 11(a), with the optical mode at the resonant wavelength of 810 nm, where the electric field strength in the middle cavity nearly vanishes, similar to FIG. 10(b).

FIG. 11(c) shows schematically the same structure as FIG. 11(a), with the optical mode at a wavelength of 811 nm, where the electric field strength in the middle cavity has a significant value.

FIG. 12 shows schematically the absorption losses of the optical mode, which has the minimum losses from the three resonating optical modes, as a function of the wavelength, revealing an extremely narrow minimum in losses.

FIG. 13(a) shows schematically the profile of the real part of the refractive index including a GaAs substrate, a first multilayered interference reflector (MIR), a first cavity, a second MIR, an absorbing element, a third MIR, a second (active) cavity including the active layers comprising quantum wells, a fourth MIR, and a contact layer.

FIG. 13(b) shows schematically the profile of the imaginary part of the dielectric function proportional to the absorption coefficient.

FIG. 13(c) shows schematically the absolute value of the electric field strength of one of three resonating optical modes at a wavelength of 850 nm.

FIG. 14(a) shows schematically the profile of the real part of the refractive index including a GaAs substrate, a first multilayered interference reflector (MIR), a first cavity, a second MIR, an absorbing element, a third MIR, a second (active) cavity including the active layers comprising quantum wells, a fourth MIR, and a contact layer.

FIG. 14(b) shows schematically the profile of the imaginary part of the dielectric function proportional to the absorption coefficient.

FIG. 14(c) shows schematically the absolute value of the electric field strength of the second resonating optical mode at a wavelength of 850 nm. The mode has a small electric field strength at the absorbing element, which implies small absorption losses.

FIG. 15(a) shows schematically the profile of the real part of the refractive index including a GaAs substrate, a first multilayered interference reflector (MIR), a first cavity, a second MIR, an absorbing element, a third MIR, a second (active) cavity including the active layers comprising quantum wells, a fourth MIR, and a contact layer.

FIG. 15(b) shows schematically the profile of the imaginary part of the dielectric function proportional to the absorption coefficient.

FIG. 15(c) shows schematically the absolute value of the electric field strength of the third resonating optical mode. Significant electric field strength at the absorbing element implies large absorption losses for this mode.

FIG. 16(a) shows schematically the profile of the imaginary part of the dielectric function, proportional to the absorption coefficient.

FIG. 16(b) shows schematically the absolute value of the electric field strength of the optical mode at the wavelength of 848 nm. The optical mode has a significant electric field strength at the absorbing element implying essential losses.

FIG. 16(c) shows schematically the absolute value of the electric field strength of the optical mode at a wavelength of 850.5 nm. The optical mode has a very small electric field strength at the absorbing element implying very small losses.

FIG. 16(d) shows schematically the absolute value of the electric field strength of the optical mode at a wavelength of 853 nm. The optical mode has a significant electric field strength at the absorbing element implying essential losses.

FIG. 17 shows schematically the reflectivity spectrum of the structure, if light impinges at the structure from a transparent layer of GaAlAs at one of three different angles.

FIG. 18 shows schematically a tilted cavity surface-emitting laser incorporating an interference filter according to another embodiment of the present invention. A narrow hole in the top contact leads to a single-lobe emission of light.

FIG. 19 shows schematically a tilted cavity surface-emitting laser incorporating an interference filter according to another embodiment of the present invention. A wide hole in the top contact leads to a multi-lobe emission of light.

FIG. 20 shows schematically a wavelength-tunable tilted cavity surface emitting laser incorporating an interference filter according to another embodiment of the present invention.

FIG. 21 shows schematically a tilted cavity surface emitting laser combined with an electrooptical modulator, designed to modulate the intensity of the emitted laser light and incorporating an interference filter, according to another embodiment of the present invention.

FIG. 22 shows schematically a tilted cavity surface emitting laser combined with an electrooptical modulator, designed to modulate the intensity of the emitted laser light and incorporating an interference filter, according to an alternative embodiment of the present invention.

FIG. 23 shows schematically a light bulb covered with an interference filter and thus emitting light in a narrow spectral region with a high efficiency in an embodiment of the present invention.

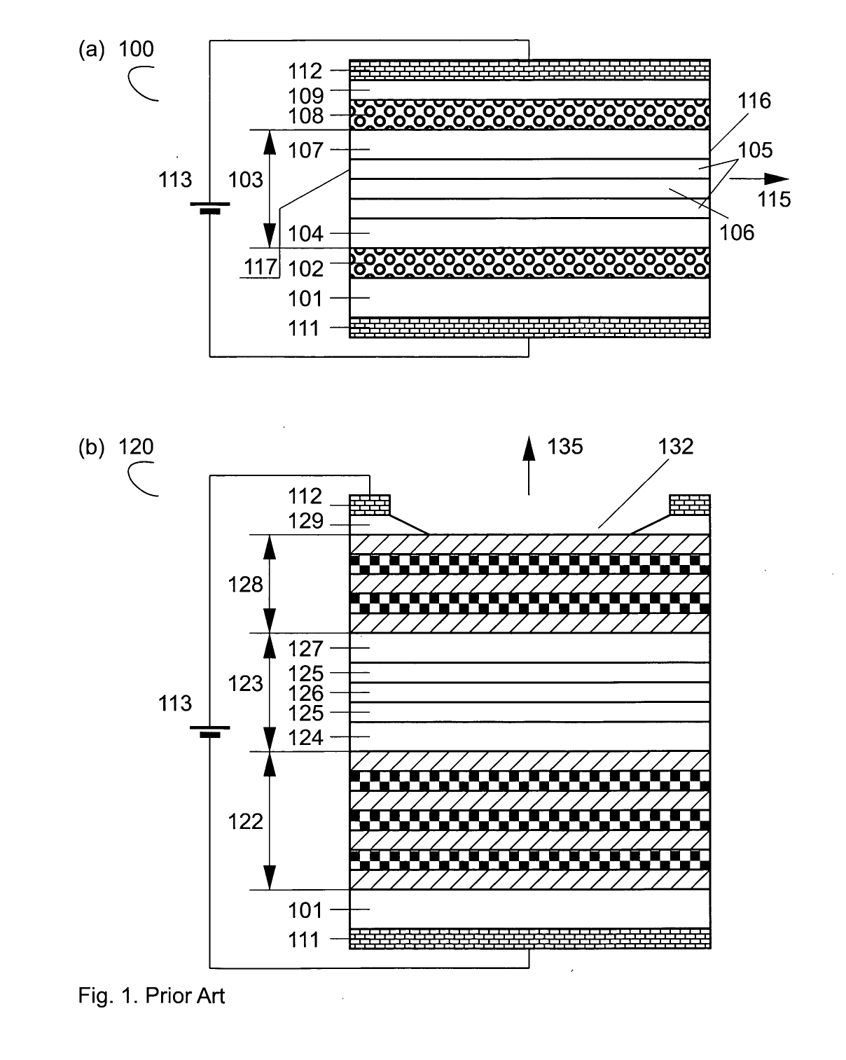

### DETAILED DESCRIPTION OF THE INVENTION

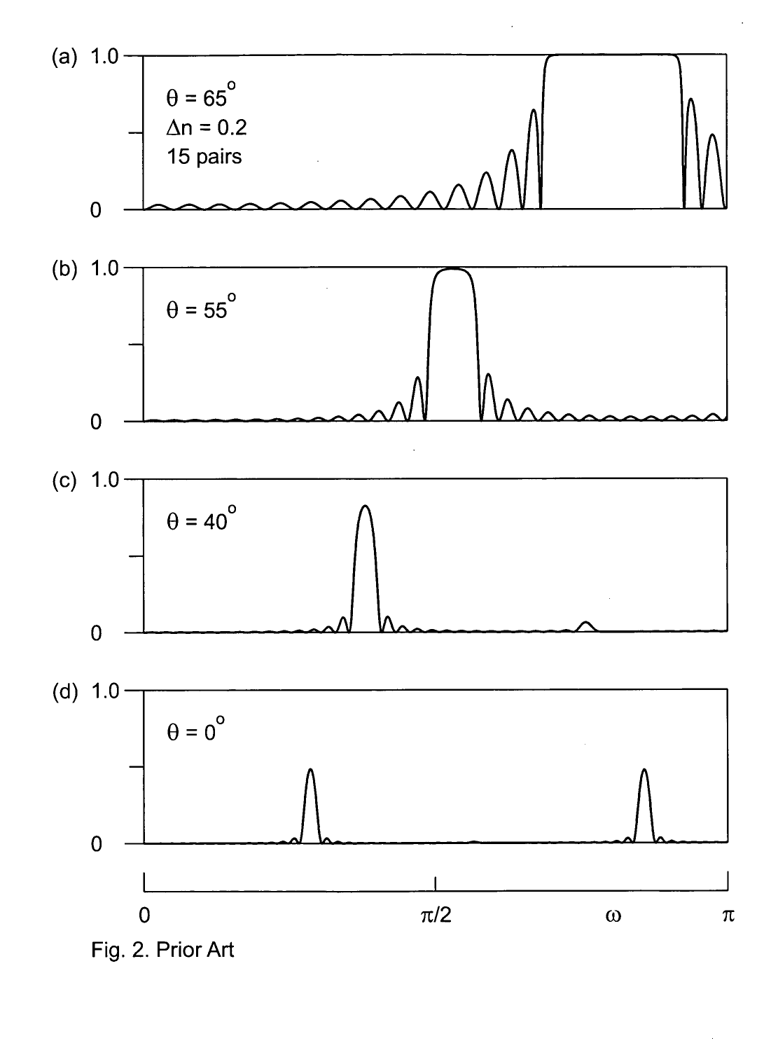

A way to overcome the shortcomings of optoelectronic devices, including, but not limited to, semiconductor diode lasers, switches, optical amplifiers, photodetectors, and light-emitting diodes, is related to different ways to construct a wavelength-selective light-emitting device. One of the ways to construct these devices is based on the fundamental physical properties of multilayered structures, i.e., on the laws of propagation, transmission, and reflection of electromagnetic waves at oblique incidence. FIG. 2 illustrates the reflectivity spectrum of a periodic multilayered structure for a few different tilt angles of the propagating TE electromagnetic wave, as described by A. Yariv and P. Yeh, in Optical Waves in Crystals. Propagation and Control of Laser Radiation, Wiley, 1984. Light comes from the medium with a refractive index n₁=3.6, and the structure includes 15 periods. Each period further includes one layer of the Λ/2 thickness having a low refractive index n₂=3.4 and one layer of equal Λ/2 thickness having a high refractive index n₁=3.6. The reflectivity is plotted as a function of the frequency ω of the electromagnetic wave, and ω is measured in units of c/Λ, where c is the speed of light in a vacuum.

The major properties illustrated in FIG. 2 are as follows. At the normal incidence, θ=0 (shown in FIG. 2(d)), the reflectivity spectrum reveals narrow spikes of a low amplitude. As the angle θ increases (shown in FIGS. 2(a) through 2(c)), spikes shift towards higher frequencies, and hence, shorter wavelengths. The amplitude of the spikes also increases, and the spikes become broader, forming stopbands with a reflectivity close to 1. The strong dependence of the reflectivity of electromagnetic waves from a multilayered structure on the angle of incidence provides the basis for a tilted cavity semiconductor diode laser. This laser was disclosed in a co-pending U.S. patent application Ser. No. 10/074,493, filed Feb. 12, 2002, herein incorporated by reference. In the tilted cavity laser, light propagates at an angle with respect to multilayer interference mirrors (MIRs), and the MIRs and the cavity are optimized for tilted photon propagation.

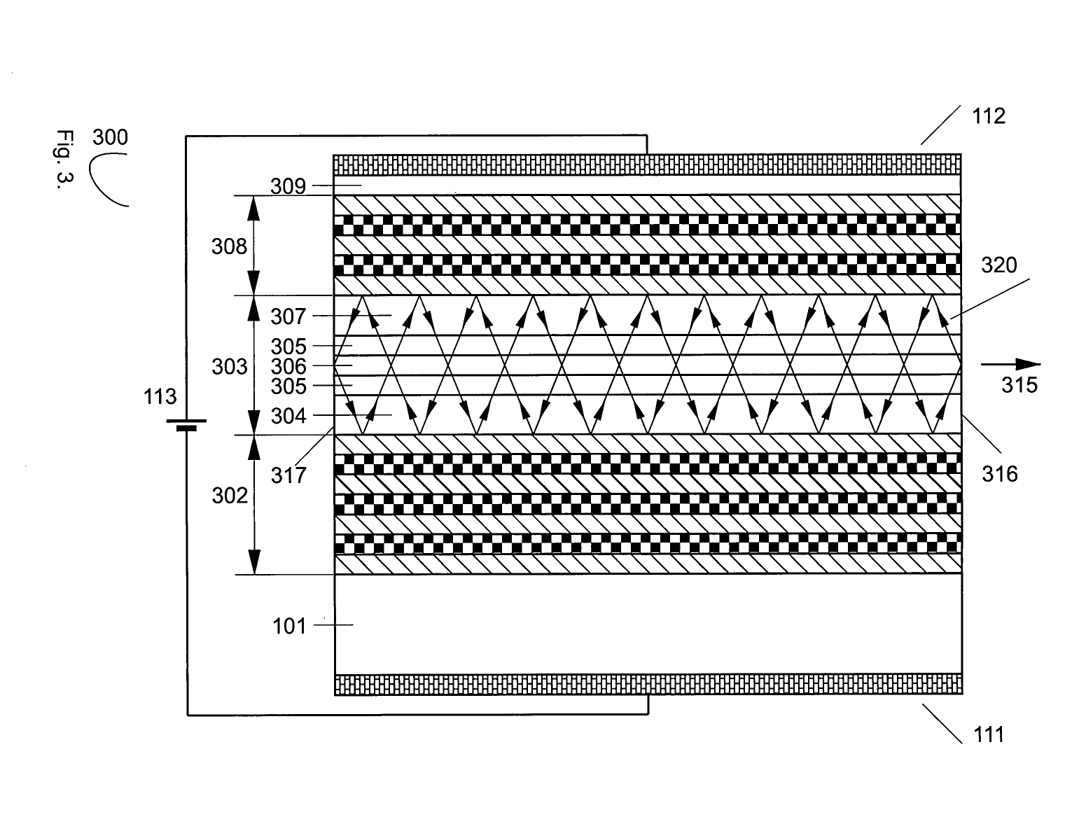

The tilted cavity laser (300) shown in FIG. 3 is grown epitaxially on an n-doped substrate (101) and includes an n-doped bottom multilayered interference reflector (MIR) (302), a cavity (303), a p-doped top multilayered interference reflector (308), and a p-contact layer (309). The cavity (303) includes an n-doped layer (304), a confinement layer (305), and a p-doped layer (307). The confinement layer (305) further includes an active region (306). The laser structure (300) is bounded in the lateral plane by a rear facet (317) and a front facet (316). The cavity (303) and the multilayered interference reflectors (302) and (308) are designed such that resonant conditions for the cavity and for multilayered interference reflectors are met for only one tilted optical mode (320), the light propagating at a certain tilt angle and having a certain wavelength. If the rear facet (317) is covered by a highly reflecting coating, the output laser light (315) comes out only through the front facet (316). One advantage of this design is that wavelength stabilization and a high output power are obtained at the same time. Since the cavity (303), together with the bottom MIR (302) and the top MIR (308), are designed such that lasing occurs in a tilted optical mode, the cavity (303) is termed “tilted cavity” herein.

The layers forming the bottom multilayered interference reflector (302) are formed from materials lattice-matched or nearly lattice matched to the substrate (101), are transparent to the generated light, are doped by a donor impurity and have alternating high and low refractive indices. For a tilted cavity laser grown on a GaAs substrate, alternating layers of GaAs and GaAlAs or layers of GaAlAs having alternating aluminum content preferably form the mirror.

The n-doped layer (304) of the cavity (303) is formed from a material lattice-matched or nearly lattice-matched to the substrate (101), is transparent to the generated light, and is doped by a donor impurity.

The p-doped layer (307) of the cavity (303) is formed from a material lattice-matched or nearly lattice-matched to the substrate (101), is transparent to the generated light, and is doped by an acceptor impurity.

The layers forming the top multilayered interference reflector (308) are formed from materials lattice-matched or nearly lattice-matched to the substrate (101), are transparent to the generated light, are doped by an acceptor impurity, and have alternating high and low refractive indices. For a tilted cavity laser grown on a GaAs substrate, alternating layers of GaAs and GaAlAs or layers of GaAlAs having alternating aluminum content preferably form the mirror.

The p-contact layer (309) is formed from a material doped by an acceptor impurity. For a tilted cavity laser grown on a GaAs substrate, the preferred material is GaAs. The doping level in the p-contact layer (309) is preferably higher than that in the top multilayered interference reflector (308).

The confinement layer (305) is formed from a material lattice-matched or nearly lattice-matched to the substrate (101), is transparent to the generated light, and is either undoped or weakly doped. The confinement layers are preferably formed from the same material as the substrate (101).

The active region (306) placed within the confinement layer (305) is preferably formed by any insertion, the energy band gap of which is narrower than that of the materials forming the bottom MIR (302), n-doped layer (304) and the p-doped layer (307) of the cavity (303) and the top MIR (308). Thus, the laser light generated in the active region is not absorbed in the neighboring layers. Possible active regions (306) include, but are not limited to, a single-layer or a multi-layer system of quantum wells, quantum wires, quantum dots, or any combination thereof. For a device on a GaAs-substrate, examples of the active region (306) include, but are not limited to, a system of insertions of InAs, In₁₋ₓGaₓAs, InₓGa_{1-x-y}Al_{y}As, InₓGa₁₋ₓAs_{1-y}N_{y} or similar materials.

It is convenient to discuss the selection of the optical modes in a diode laser by considering the oscillation conditions of a laser, following, e.g. H. C. Casey, Jr., and M. B. Panish, Heterostructure Lasers, Part A, pp. 165-167. Casey and Panish considered a model picture of a laser oscillator formed by use of parallel reflecting surfaces for a medium with gain, where the medium bounded by two parallel surfaces may be considered a Fabry-Perot interferometer. The oscillation condition can be obtained by considering the plane-wave reflection between partially reflecting surfaces. The oscillation conditions imply that the amplification of radiation exactly balances the total losses. Then, for a structure having a cavity length L, the oscillation conditions may be written for a given i-th optical mode as follows,

$${g}_{i}^{mod} = {α}_{i} + ( \frac{1}{L} ) ln ( \frac{1}{{r}_{1} {r}_{2}} ) , \qquad ( 1 )$$

Where gᵢ^{mod} is the modal gain of the i-th optical mode, r₁ and r₂ are amplitude reflection coefficients from the two surfaces, αᵢ refers to the total losses, and g is the gain. Eq. (1) yields a threshold value of gain, at which lasing starts. For practical structure of an edge-emitting laser, the following is taken into account. First, the gain, the losses, and the reflection coefficients depend on a particular optical mode. Second, the modal gain of an i-th optical mode can be written in terms of the material gain gₘₐₜ and the optical confinement coefficient of a given optical mode Γᵢ,

$${g}_{i}^{mod} = {g}_{mat} {Γ}_{i} . \qquad ( 2 )$$

Third, the losses αᵢ can be written as a sum of the absorption losses and leaky losses,

$${α}_{i} = {α}_{i}^{absorption} + {α}_{i}^{leaky} . \qquad ( 3 )$$

Here, absorption losses refer to the absorption of electromagnetic power within the structure in absorbing layers, whereas leaky losses refer to the leakage of the power to the substrate and/or contact layers. Substituting Eqs. (2, 3) into Eq. (1) yields,

$${g}_{mat} = \frac{1}{{Γ}_{i}} [ {α}_{i}^{leaky} + {α}_{i}^{absorption} + ( \frac{1}{L} ) ln ( \frac{1}{{r}_{1 , i} {r}_{2 , i}} ) ] . \qquad ( 4 )$$

Eq. (4) yields the threshold value of the material gain in the active region of a laser. The threshold value of the material gain is related to the threshold current density and is different for different optical modes and for different wavelengths. If a laser is designed such that the total losses, given by the sum of three contributions in the square brackets in Eq. (4), are minimum for a certain wavelength within the gain spectrum and increase away from this wavelength, then lasing will start just at the optimum wavelength.

Effective Angle of Optical Modes

To illustrate the principles of constructing a wavelength-stabilized tilted cavity laser, it is convenient to discuss an effective angle of optical modes.

In most of the embodiments of the present invention, the tilted cavity optoelectronic device includes a multilayered structure, in which a refractive index is modulated in the direction perpendicular to the p-n junction plane. The coordinate reference frame is hereby defined such that the p-n junction plane is the (xy) plane. The refractive index n is modulated in the z-direction, n=n(z). Then, in any optical mode, the temporal and spatial behavior of the electric (E) and magnetic (H) fields is written as follows,
\tilde{E}ᵢ(x, y, z; t)=Re[exp(−iωt)exp(iβₓx+iβ_{y}y)Eᵢ(z)], (5a)
\tilde{H}ᵢ(x, y, z; t)=Re[exp(−iωt)exp(iβₓx+iβ_{y}y)Hᵢ(z)], (5b)
where ω is the frequency of light, βₓ and β_{y} are propagation constants, Re stands for the real part of a complex number, and the index i=x, y, z. The axes x and y are defined such that the propagation constants are
βₓ=β and β_{y}=0. (6)

Then, for TE (transverse electric) optical modes the Maxwell's equations reduce to a scalar equation for the only non-zero component of the electric field, E_{y}(z),

$$- \frac{{ⅆ}^{2}}{ⅆ {z}^{2}} {E}_{y} ( z ) + {β}^{2} {E}_{y} ( z ) = {n}^{2} ( z ) \frac{{ω}^{2}}{{c}^{2}} {E}_{y} ( z ) , \qquad ( 7 )$$

as shown previously by H. C. Casey, Jr. and M. B. Panish in Heterostructure Lasers, Part A, Academic Press, New York, 1978, pp. 34-57. Most practical structures used in optoelectronic devices are layered structures where the refractive index within each i-th layer is constant, and
n(z)=nᵢ. (8)

Then the solution of Eq. (7) within the i-th layer may be written as a linear combination of two waves,
E_{y}(z)=A exp(iqᵢz)+B exp(−iqᵢz), (9a)
where

$${q}_{i} = \sqrt{{n}_{i}^{2} \frac{{ω}^{2}}{{c}^{2}} - {β}^{2}} , if {n}_{i} \frac{ω}{c} > β , \qquad ( 9 b )$$

or
E_{y}(z)=C exp(κᵢz)+D exp(−κᵢz), (10a)
where

$${κ}_{i} = \sqrt{{β}^{2} - {n}_{i}^{2} \frac{{ω}^{2}}{{c}^{2}}} , if {n}_{i} \frac{ω}{c} < β . \qquad ( 10 b )$$

In Eq. (10b), if the electric field within the i-th layer is a standing wave, which is a combination of two traveling waves, each of the traveling waves within this particular i-th layer propagates at an angle θ or −θ with respect to the axis z, where

$$ϑ = {tan}^{- 1} \frac{β}{{q}_{i}} . \qquad ( 11 )$$

In the case of Eq. (10b), the electric field within the i-th layer is the combination of increasing and decreasing exponentials, and it is not possible to define an angle.

It should be noted that the effective angle of propagation can be defined only with respect to some reference frame. In most of the embodiments of the present invention, it is convenient to define the angle with respect to the direction normal to a p-n junction plane, This is done throughout the remainder of the present application.

FIG. 2 shows that the optical properties, e.g. the reflection or transmission coefficients of any multilayered structure depend dramatically on the angle of incidence of the electromagnetic wave. This property of multilayered structures is employed in all embodiments of the present invention. Therefore, it is convenient to characterize any optical mode by its angle of propagation. When the angle is defined in accordance with Eq. (11), the angle is different for different layers. From hereto forward the following conventions are used. One layer is fixed as the reference layer, and its refractive index is denoted as n₀. A layer with a high refractive index is preferably chosen as the reference layer. Preferably, it is the layer having the maximum refractive index nₘₐₓ or a layer having a refractive index close to the maximum refractive index. For example, in a multilayered structure including layers of GaAs and Ga₁₋ₓAlₓAs, a layer of GaAs is preferably chosen as the reference layer, if GaAs is transparent for light at a given wavelength. All layers of Ga₁₋ₓAlₓAs typically have refractive indices lower than the reference layer of GaAs, and the optical modes have propagation constants that obey the relationship

$$β < {n}_{max} \frac{ω}{c} = {n}_{0} \frac{ω}{c} , \qquad ( 12 )$$

and the electric field of the optical modes within the reference layer are a combination of traveling waves according to Eq. (5a). Thus, it is possible to define the angle of propagation within the GaAs layer, according to Eq. (11).

If InAs or GaInAs layers, for example, in quantum well or quantum dot layers, are present in the structure, their refractive indices may be higher than that of GaAs. However, their thickness is typically very small, and these layers do not make a dramatic impact on the propagation constants β of the optical modes, and the relationship

$$β < {n}_{0} \frac{ω}{c} , \qquad ( 13 )$$

is still valid for the optical modes. Thus, in what follows, every optical mode is assigned an angle θ, according to

$$ϑ = {tan}^{- 1} \frac{β}{\sqrt{{n}_{0}^{2} \frac{{ω}^{2}}{{c}^{2}} - {β}^{2}}} , \qquad ( 14 )$$

where n₀ is the refractive index of the reference layer. For GaAs-based optoelectronic devices, a GaAs layer is chosen as the reference layer. It is possible to choose a layer as the reference layer even when such a layer is not present in the structure and all layers present have refractive indices lower than that of the reference layer. For example, if the structure includes the layers of Ga₁₋ₓAlₓAs with different values of aluminum composition x, and no layer of GaAs is present in the structure, it is still possible to choose a layer of GaAs as the reference layer in order to define the angle θ.

A major advantage of describing the optical modes by an angle θ relates to the following. When a complete layered structure of the optoelectronic device is considered, the optical modes are found from the solution of Eq. (7). Then each optical mode has its propagation constant β and the corresponding angle of propagation θ defined according to Eq. (14). In this case, describing the optical modes by their propagation constants or by the angles is equivalent.

A striking difference arises when optical properties of a single element of a device, and not of the whole device, are considered. Then the optical modes are not defined for a single element. However, optical properties of a single element are described, if one considers the reflectivity spectrum of this element at a certain angle of incidence. For example, a method described in U.S. patent application Ser. No. 10/943,044, filed Sep. 16, 2004, by the inventors of the present invention and herein incorporated by reference, is based on a resonance between a high-finesse cavity and a multilayer interference reflector (MIR) which occurs only at a single tilt angle and a single wavelength. The cavity and the MIR are designed such that the cavity has a narrow dip in the reflectivity spectrum, and the MIR has a stopband in the reflectivity spectrum. At a certain optimum tilt angle, the cavity dip and the maximum stopband reflectivity coincide at a certain wavelength. As the tilt angle deviates from the optimum angle, the cavity dip and the maximum stopband reflectivity draw apart. If the wavelength of light is at resonance, the optical modes propagate at an optimum angle, for which the reflectivity of the MIR is high, light is effectively confined in the cavity, and leakage losses are low. If the wavelength of light is far from resonance, the optical mode propagates at a different angle, for which the MIR reflectivity is low, and leakage losses are high. Such an approach ensures the selectivity of the leaky losses and provides wavelength-stabilized operation of the laser.

The present invention discloses a novel approach to obtain the wavelength stabilized operation of an optoelectronic device. The present invention uses at least two resonantly coupled cavities.

Two Resonantly Coupled Cavities

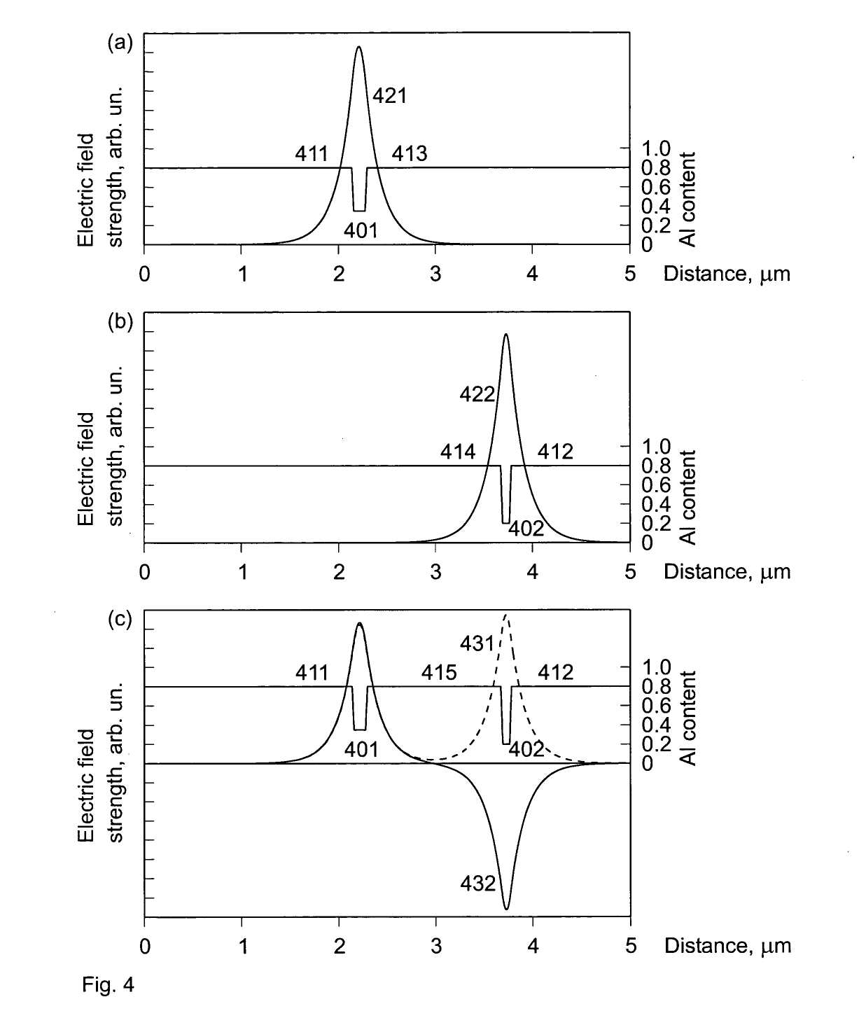

FIG. 4 illustrates a generic structure with two resonantly coupled cavities and the optical modes of this structure. The structure in FIG. 4 is a multilayered GaAlAs-based structure. FIG. 4(a) shows a cavity (401) sandwiched between two cladding layers (411) and (413). The aluminum content profile and the electric field strength profile in a localized optical mode are shown. The electric field strength is shown in arbitrary units. The structure is based on GaAlAs layers, and a higher aluminum content generally implies a lower refractive index. Thus, the cavity (401) localizes an optical mode (421). The propagation constant β is determined by solving the eigenvalue problem stated by Eq. (7), and is a function of the wavelength of light λ,
β=β₁(λ). (15a)
In terms of the effective angle of the optical mode, the dispersion law of the first cavity is as follows:

$${ϑ}^{eff} = {ϑ}_{1}^{eff} ( λ ) . \qquad ( 15 b )$$

FIG. 4(b) shows another cavity (402) sandwiched between a cladding layer (414) and a cladding layer (412). The aluminum content profile and the electric field strength profile in a localized optical mode are shown. The cavity (402) localizes the optical mode (422). The propagation constant of the optical mode is again a function of the wavelength of light, following a different dispersion law,
β=β₂(λ). (16a)
In terms of the effective angle of the optical modes, the dispersion law of the second cavity is as follows

$${ϑ}^{eff} = {ϑ}_{2}^{eff} ( λ ) . \qquad ( 16 b )$$

If one compares the localization strength of the two cavities (401) and (402), these two as shown in FIGS. (4a) and (4b) demonstrate two competing tendencies. On the one hand, the width of the cavity (401) is larger than that of (402), which would imply larger localization strength for the cavity (401). On the other hand, the refractive index difference between the cavity and the cladding layers is larger for the cavity (402) than for the cavity (401), which would imply larger localization strength for the cavity (402). Due to these competing tendencies, a resonance may occur at a certain wavelength λ*, where the values of the propagation constants given by the two dispersion laws (15a) and (16a) match,
β₁(λ*)=β₂(λ*). (17a)
In terms of the effective angle of propagation of the optical mode, the matching criterion (17a) takes the form,

$${ϑ}_{1}^{eff} ( {λ}^{*} ) = {ϑ}_{2}^{eff} ( {λ}^{*} ) . \qquad ( 17 b )$$

FIG. 4(c) illustrates the resonance situation. The structure includes a cladding layer (411), followed by a cavity (401), followed by a cladding layer (415), followed by a cavity (402), followed by a cladding layer (412). In the particular embodiment of FIG. 4, the cavity (401) has a thickness 138 nm and Aluminum content 35%. The cavity (402) has a thickness 90 nm and Aluminum content 20%. The cladding layers (411), (412), and (415) have Aluminum content 80%, and the layer (415) has a thickness 1400 nm. At resonance, the optical modes are the linear combination of the mode of the cavity (401) and that of the cavity (402). The symmetric optical mode (431) is shown by a dashed line, and the antisymmetric mode (432) is depicted by the solid line. At resonance, two localized optical modes extend over both cavities and are linear combinations of the optical modes of individual cavities. These are a symmetric nodeless mode and an antisymmetric mode having a node between two cavities.

The important features of the resonant state of the two coupled cavities are the nodeless symmetric optical mode, and the antisymmetric optical mode with one node between the cavities. A key point of the present invention is related to the position of the node of the antisymmetric mode as a function of the wavelength of light.

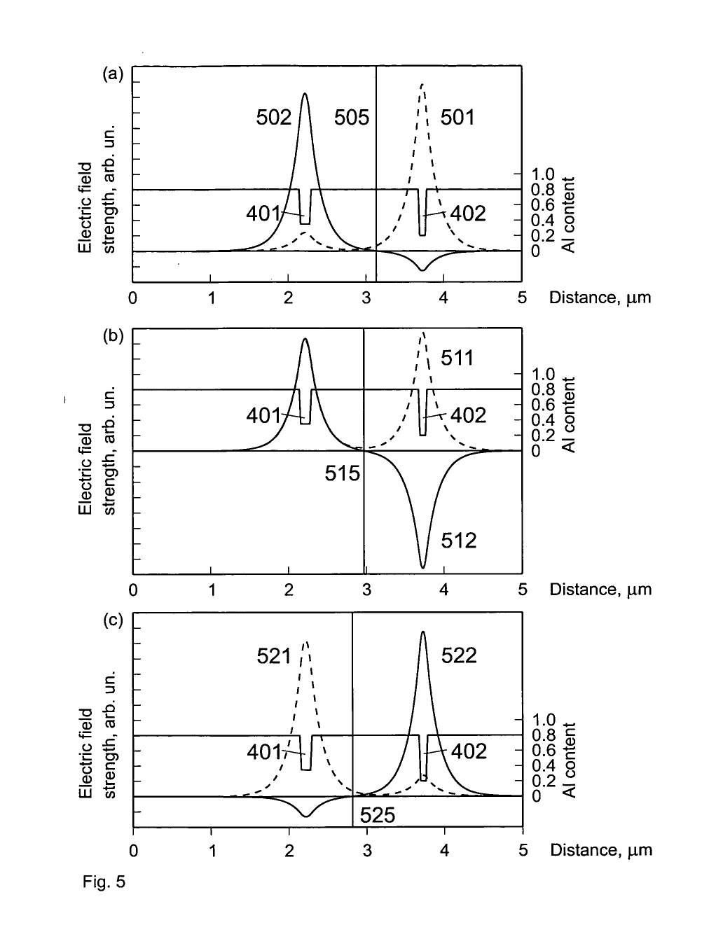

FIG. 5 illustrates the shift of the position of the node of the antisymmetric mode as a function of the wavelength of light. The two coupled cavities are designed such that they are at resonance at a wavelength of 810 nm. FIG. 5(a) shows the structure of two coupled cavities (401) and (402) and the optical modes at a wavelength of 809 nm, which is slightly off resonance. In this figure, the wavelength is slightly off resonance such that the position of the node of the optical mode having a node is shifted from the middle towards the second cavity.

The nodeless optical mode (501) (shown by a dashed line) has a larger electric field strength at the cavity (402), and a smaller electric field strength at the cavity (401). In contrast, the optical mode (502) (shown by a solid line), which has a node, has a larger electric field strength at the cavity (401) and a smaller electric field strength at the cavity (402). The position of the node (505) is then shifted from the middle point between the two cavities towards the cavity (402). In other words, the position (505) is more distant from the cavity (401) than from the cavity (402). At this position, the initially stronger contribution of the cavity (401) to the electric field of the optical mode (501) is more damped compared to its value at the cavity (401), and the initially weaker contribution of the cavity (402) to the electric field is less damped compared to its value at the cavity (402). As a result, the two contributions to the optical mode (502) cancel out at the position (505), resulting in the node of the optical mode.

FIG. 5(b) shows the two optical modes at resonance, at a wavelength of light of 810 nm. The node of the optical mode having a node is placed in the middle between the two cavities. The nodeless optical mode (511) is shown by a dashed line, whereas the optical mode (512) shown by a solid line has the node (515) positioned at the middle between the two cavities.

FIG. 5(c) shows the two optical modes at a wavelength of 811 nm, shifted off the resonance to longer wavelengths. In this figure, the position of the node of the optical mode having a node is shifted from the middle towards the first cavity. The nodeless optical mode (521) is shown by a dashed line, and the optical mode (522) shown by a solid line has a node at the position (525), which is closer to the cavity (401), than to the cavity (402). Thus, FIGS. 5(a) through 5(c) illustrate that the position of the node of a resonant optical mode shifts as a function of the wavelength of light.

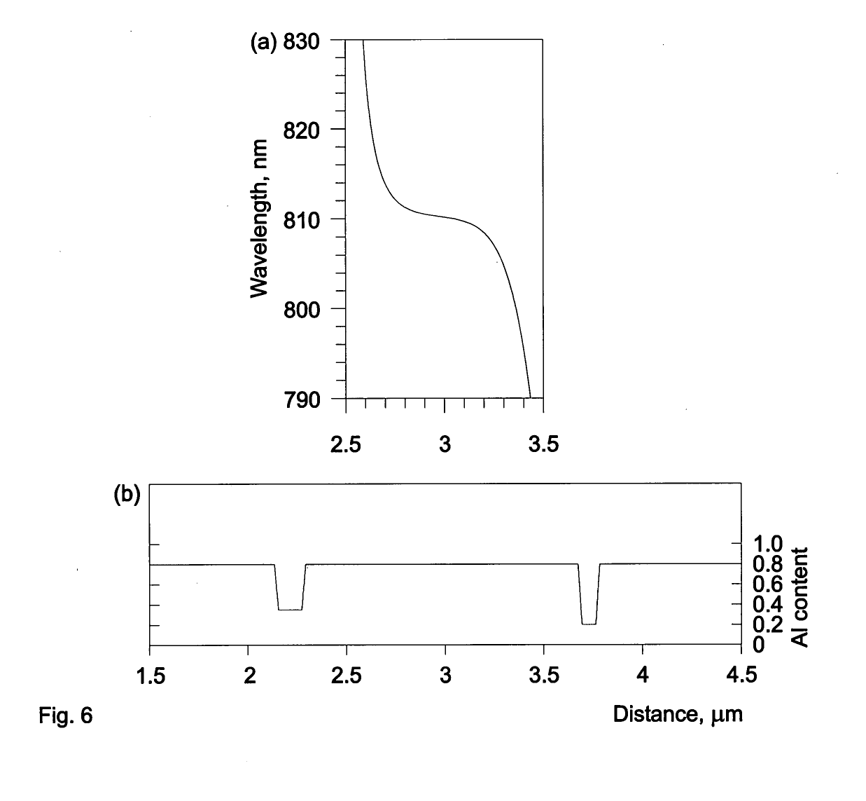

FIG. 6(b) shows the aluminum content in the GaAlAs-based structure, and FIG. 6(a) shows the position of the node of the optical mode, having a node between the two cavities, as a function of the wavelength of light. It follows from FIG. 6(a) that the shift of the node position is very fast when the system passes the resonant state at the wavelength of 810 nm, and the node passes the middle point between the two cavities. The further the wavelength is from the resonant value of 810 nm, the slower the shift of the node position upon the wavelength.

Filter Containing a Non-Transparent Element

The filter of the present invention includes at least two cavities, which are at resonance at a certain wavelength of light and at a certain angle of propagation of light, and a non-transparent element placed between the two cavities. The non-transparent element is preferably an absorber, a scatterer, or a reflector. If the non-transparent element is placed at a position where the electric field strength of a given optical mode is close to zero, the non-transparent element does not affect the optical mode. If an optical mode has a significant electric field strength at the location of the non-transparent element, this mode is heavily influenced by this element. When the non-transparent element is an absorber, this leads to absorption losses of the given optical mode. When the non-transparent element is a scatterer, it leads to scattering of the given optical mode. In both of these groups of embodiments, the low losses are preferably smaller than any of the high losses by at least a factor of five. When the non-transparent element is a reflector, this stops propagation of the optical mode through the structure. In this group of embodiments, there is a first transmission coefficient of the device at resonance, occurring at at least one selective wavelength for light propagating in one of the optical modes, which is high. There are also a second transmission coefficient of the device at resonance, occurring at at least one selective wavelength for light propagating in all of the other optical modes, and a third transmission coefficient of the device off resonance, for light propagating in any optical mode. The second transmission coefficient and the third transmission coefficient are low. In a preferred embodiment, the first transmission coefficient is larger than the second transmission coefficient and the third transmission coefficient by at least a factor of five.

Incorporating the filter into a semiconductor diode laser results in high losses of the optical modes off resonance. This suppresses lasing of the optical modes, which are out of resonance. Thus, such a laser has a strong selectivity in the lasing wavelength as only the optical mode at resonance has a very small intensity at the absorber and lases.

Incorporating the filter into an optical amplifier results in high losses of the optical modes off resonance. This suppresses amplification of the optical modes, which are out of resonance. Thus, such a laser has a strong selectivity in the wavelength of the output amplified light as only the optical mode at resonance has a very small intensity at the absorber and is amplified.

Incorporating the filter into a photodetector results in high losses of the optical modes off resonance. This suppresses the propagation of light at wavelengths off resonance as such light is absorbed or scattered at the non-transparent element of the filter. Thus, such a device operates as a wavelength-selective photodetector, as only the optical mode at resonance will have zero or very low parasitic absorption or scattering at the elements of the device other than the photodetecting p-n junction. The resonant mode is thus effectively absorbed at the photodetecting p-n junction resulting in photocurrent.

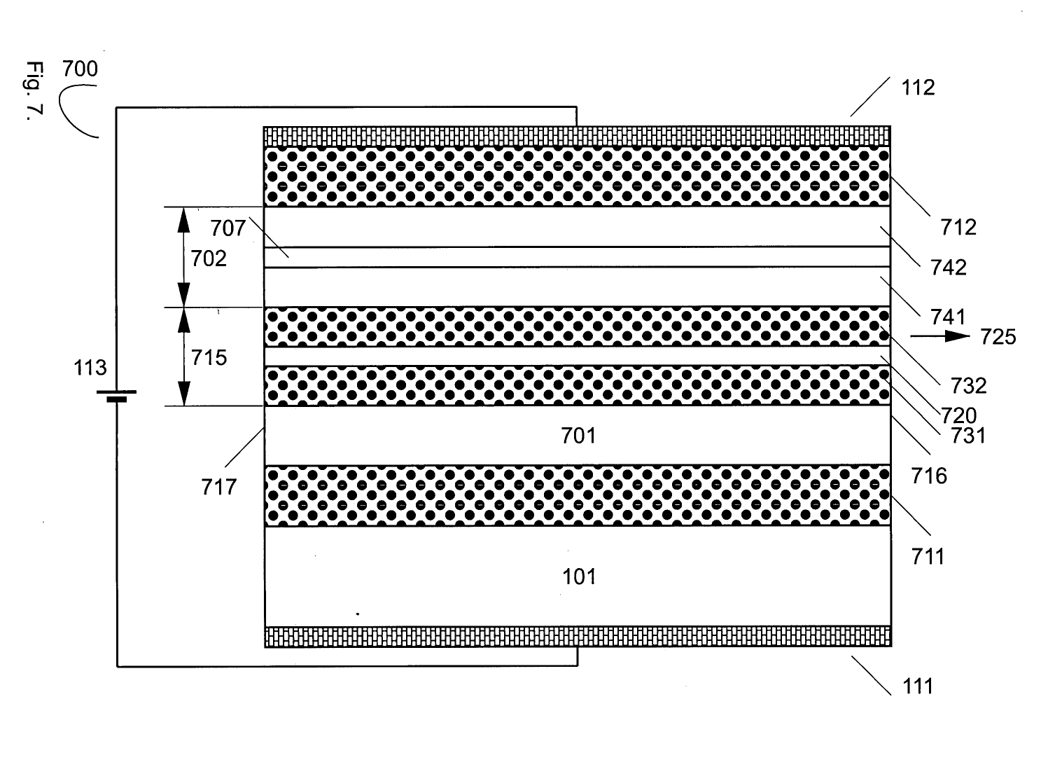

FIG. 7 shows an example of the optoelectronic device incorporating a filter based on a non-transparent element. In this embodiment, the laser structure includes two cavities, each of which is sandwiched by evanescent reflectors, the two cavities being coupled via the middle evanescent reflector. A non-transparent element is placed within the middle reflector, resulting in high losses of the optical modes except those having a node at the non-transparent element, which yields an efficient selection of the optical modes.

The tilted cavity semiconductor diode laser (700) includes a substrate (101), a first reflector (711), a first cavity (701), a second reflector (715), a second cavity (702), and a third reflector (712).

The substrate (101), the first reflector (711), the first cavity (701), and the second reflector (715) are preferably n-doped. The n-doped second reflector (715) includes a first part (731), preferably n-doped, a non-transparent element (720), and a second part (732), also preferably n-doped.

The second cavity (702) includes an n-doped layer (741), an active element (707), and a p-doped layer (742). The third reflector (712) is preferably p-doped.

The first cavity (701), the second cavity (702), and reflectors (711), (715), and (712) are preferably designed such that the two cavities (701) and (702) are at resonance in a certain spectral region around a certain wavelength λ*, where two optical modes are extended over both the first cavity (701) and the second cavity (702). One of the two modes has a node between the two cavities. The node shifts as a function of the wavelength. At a certain wavelength, λ*, the node coincides with the position of a non-transparent element (720).

In one of the embodiments of the present invention, the non-transparent element is an absorbing element, including at least one absorbing layer. The absorbing layer is preferably formed of any of the following:
a semiconductor material having an energy bandgap narrower than the photon energy corresponding to the resonant wavelength of light λ*;
insertions of quantum wells, wires, or dots, or their combinations, where the absorption edge of quantum insertions is below the photon energy corresponding to the resonant wavelength of light λ*;
a semiconductor layer containing a high density of defects. The defects may include one or more of any of the following: i) a metamorphic layer obtained via lattice-mismatched growth and containing a high density of extended or point defects; ii) a layer containing dislocated quantum dots; iii) a layer containing dislocated quantum wires; iv) a layer grown at a low temperature; or v) a layer containing metallic precipitates; or
a metallic insertion, which absorbs light.

All three reflectors (711), (715), and (712) are preferably designed in this embodiment as evanescent reflectors, in which the optical mode exhibits exponential behavior. The resonant optical mode having a node at the non-transparent element decays exponentially away from the cavities in both the first evanescent reflector (711) and the third evanescent reflector (712). Within the second evanescent reflector (715), the optical mode is a linear combination of decaying and growing exponentials, similar to the modes shown in FIG. 4(c) and 5(c).

The tilted cavity laser (700) operates in the edge-emitting geometry. In a preferred embodiment, the front facet (716) is preferably covered by an anti-reflective (AR) coating, and the rear facet (717) is preferably covered by a high-reflective (HR) coating. In this embodiment, the generated laser light comes out (725) through the front facet.

All the other optical modes, other than the resonant optical mode, have non-vanishing electric field strength at the non-transparent element (720), which leads to high losses of these modes due to absorption or scattering. The resonant optical mode at wavelengths far from the resonant wavelength, λ*, has non-vanishing electric field strength at the non-transparent element (720), and, therefore, high losses. The resonant optical mode in a narrow spectral interval close to the resonant wavelength, λ*, has vanishing electric field strength at the non-transparent element (720), and, therefore, low losses. This ensures wavelength selectivity of the laser.

If even the minimum losses of the optical mode due to the non-transparent element (720) are significant, the electric field strength profile of the optical mode, which can be obtained by solving Eq. (7), is no longer a real function of the coordinate z, but a complex function. Then, such an optical mode will not have exact nodes. But, at resonance, the absolute value of the complex electric field strength at the non-transparent element has the minimum value, and this minimum value is significantly lower than the electric field strength in other optical modes.

A semiconductor diode laser of the embodiment of FIG. 7 operates in an optical mode having a node between two cavities. This is a key point of the present invention. The optical mode showing minimum losses may have also other nodes, besides this one, but it has at least one node. Thus, this mode cannot be the fundamental optical mode in the vertical direction. The optical mode having a node is necessarily a high-order vertical mode. Therefore, even for a diode laser operating in an edge-emitting geometry, it operates in a tilted mode and may be regarded as a tilted cavity laser. Similarly, an optical amplifier in this embodiment is a tilted cavity optical amplifier and a resonant cavity photodetector is a resonant tilted cavity photodetector.

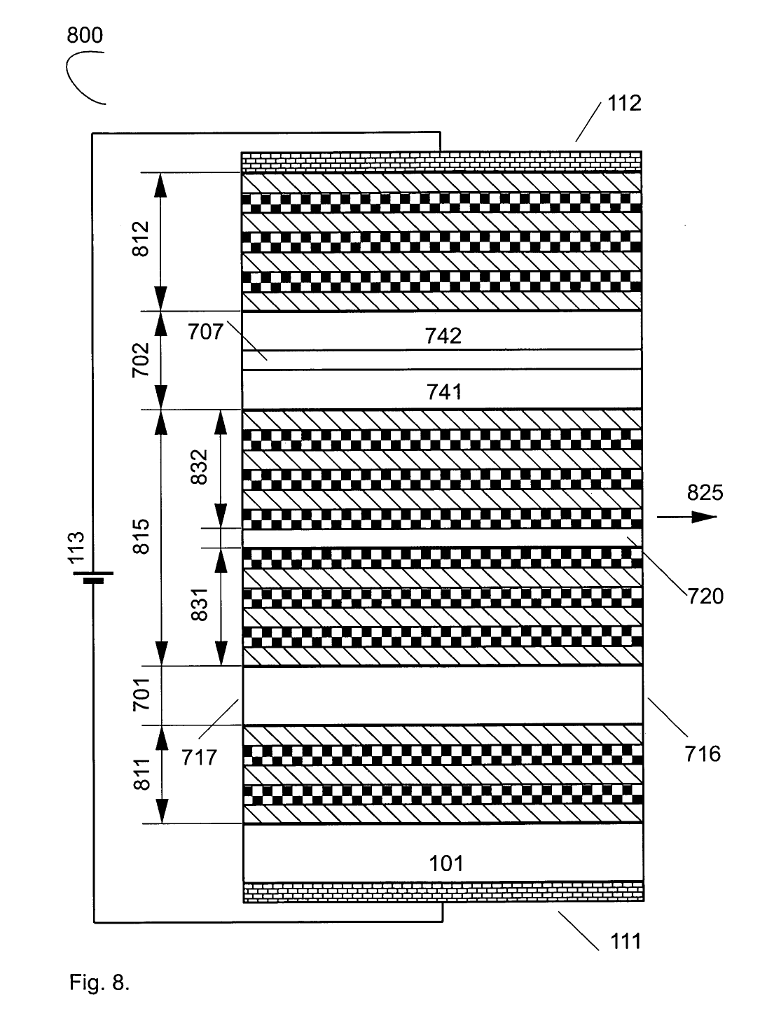

FIG. 8 shows a tilted cavity semiconductor diode laser (800) incorporating an interference filter according to another embodiment of the present invention. In this embodiment, the laser structure includes two cavities, each of which is sandwiched by multilayer interference reflectors (MIRs). The two cavities are coupled via the middle MIR. A non-transparent element is placed within the middle MIR, resulting in high losses of the optical modes except those having a node at the non-transparent element, which yields an efficient selection of the optical modes. The light comes out through a side facet, in an edge-emitting geometry.

Unlike the embodiment in FIG. 7, the reflectors are realized as multilayered interference reflectors (MIRs) in this embodiment. The laser structure (800) includes a preferably n-doped MIR (811), a preferably n-doped first cavity (701), a preferably n-doped second MIR (815), a second cavity (702), and a preferably p-doped third MIR (812). The second MIR (815) includes a first part of the MIR (831), a non-transparent element (720), and a second part of the MIR (832). The operation of the laser (800) is wavelength-selective, and the generated light comes out (825) through the front facet (716).

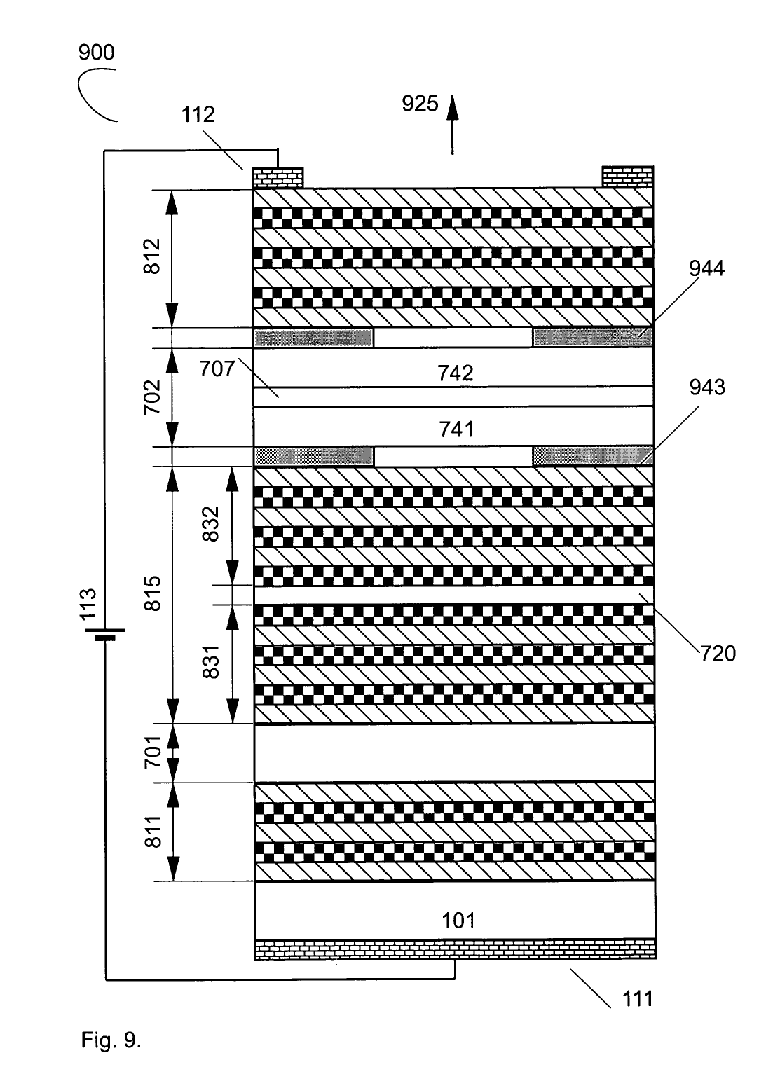

FIG. 9 shows a tilted cavity semiconductor diode laser (900) incorporating an interference filter according to another embodiment of the present invention. In this embodiment, the laser structure includes two cavities, each of which is sandwiched by multilayer interference reflectors (MIRs). The two cavities are coupled via the middle MIR. A non-transparent element is placed within the middle MIR, resulting in high losses of the optical modes except those having a node at the non-transparent element, which yields an efficient selection of the optical modes. The light comes out through a top MIR, in a surface-emitting geometry.

This embodiment differs from the embodiment in FIG. 8 in that the cavities and the multilayered interference reflectors are designed such that the tilt angle of the resonant optical mode with respect to the direction normal to the p-n junction plane is rather small, preferably smaller than the angle of the total internal reflection at the semiconductor/air interface. In this embodiment, it is possible to realize the light output (925) through the top MIR (812), in a surface-emitting geometry.

It should be noted that the one or two contacts may be realized as intracavity contacts. In this case, one, or two, or three MIRs can be made undoped.

Different embodiments of the interference filter are possible, including different types of cavities. In one embodiment, a cavity can be a waveguiding cavity, the refractive index of which is larger than the refractive index of the surrounding reflectors,
n_{waveguide}>n_{reflector}. (18)

The particular definition of the average refractive index of a multilayer interference reflector (MIR) depends on the propagation angle of the optical mode in question. As an estimate, one may define the average refractive index of a MIR as a square root of the weighted averaged square of the refractive index. Thus, for a MIR including a periodic structure, where each period further includes a first layer of a thickness d₁ and a refractive index n₁, and a second layer of a thickness d₂ and a refractive index n₂, the effective refractive index of the MIR is approximated as

$${n}_{MIR} = \sqrt{\frac{{n}_{1}^{2} {d}_{1} + {n}_{2}^{2} {d}_{2}}{{d}_{1} + {d}_{2}}} . \qquad ( 19 )$$

If a reflector is realized as a MIR, a cavity localizing an optical mode can also be an antiwaveguiding cavity, the refractive index of which is less than the average index of the MIR,
n_{antiwaveguide}<N_{MIR}. (20)

If the MIR is a periodic structure, any combination of layers breaking the periodicity form an optical defect of the periodic structure. The defect can be either localizing or delocalizing. The defect is regarded as a cavity herein.

The strong wavelength selectivity of the operation of optoelectronic devices incorporating the interference filter disclosed in the present invention are also wavelength-stabilized against, e.g., variations of ambient temperature.

Three Resonantly Coupled Cavities: a Working Example from Linear Algebra

Frequently when constructing optoelectronic devices, an absorbing element has a high refractive index and may be considered a cavity. Thus, starting from a structure with two resonantly coupled cavities and an absorber, a structure with three cavities, where the absorber is inserted into the middle cavity, needs to be considered. Therefore, it is worthwhile to discuss the properties of a structure including three cavities. It is then convenient to consider first a simple example from linear algebra.

First, consider a real symmetric three-diagonal matrix, whereas i) all elements on the main diagonal are equal, and ii) all elements on the neighboring diagonals are equal. Then it may be written as follows:

$$[ \begin{matrix}{E}_{0} & V & 0 \\ V & {E}_{0} & V \\ 0 & V & {E}_{0}\end{matrix} ] \qquad ( 21 )$$

A physical example related to this matrix is a structure including three cavities, where i) all three cavities are at a given wavelength at resonance, and ii) the tunnel coupling between the first and the second cavity is equal to the tunnel coupling between the second and the third cavity.
A straightforward substitution shows that the vector

$$\frac{1}{\sqrt{2}} \vert \begin{matrix}1 \\ 0 \\ - 1\end{matrix} 〉 \qquad ( 22 )$$

is an eigenvector of the matrix of Eq. (21) corresponding to the eigenvalue E₀,

$$[ \begin{matrix}{E}_{0} & V & 0 \\ V & {E}_{0} & V \\ 0 & V & {E}_{0}\end{matrix} ] \frac{1}{\sqrt{2}} \vert \begin{matrix}1 \\ 0 \\ - 1\end{matrix} 〉 = {E}_{0} \times \frac{1}{\sqrt{2}} \vert \begin{matrix}1 \\ 0 \\ - 1\end{matrix} 〉 . \qquad ( 23 )$$

An important feature of this eigenvector is that its second component is zero.

If a non-transparent element is placed within the second cavity, it does not affect the resonant optical mode. This ensures the selectivity of the optical modes, as only one mode has low losses.

If the cavities are designed such that two cavities, for example the second cavity and the third cavity, have the same dispersion law,
β=β₂(λ)≡β₃(λ), (24a)
or, in terms of the effective angle of propagation,

$${ϑ}^{eff} = {ϑ}_{2}^{eff} ( λ ) ≡ {ϑ}_{3}^{eff} ( λ ) . \qquad ( 24 b )$$

and the first cavity has a different dispersion law,
β=β₁(λ)≠β₂(λ), (25a)
or, in terms of the effective angle,

$${ϑ}^{eff} = {ϑ}_{1}^{eff} ( λ ) \neq {ϑ}_{2}^{eff} ( λ ) . \qquad ( 25 b )$$

Then the two dispersion laws can match at a selective wavelength λ*, at which
β₁(λ*)=β₂(λ*), (26a)
or, in terms of the effective angle

$${ϑ}_{1}^{eff} ( {λ}^{*} ) = {ϑ}_{2}^{eff} ( {λ}^{*} ) . \qquad ( 26 b )$$

Since the second and the third cavities are designed to be at resonance at all wavelengths, as described by Eqs. (24a) and (24b), at the wavelength λ* all three cavities are at resonance, which corresponds to the matrix of Eq. (21).

At the selective wavelength λ* there exists an optical mode of the system of three resonantly coupled cavities, which is essentially zero in the second cavity (the intermediate cavity of the three cavities). If a non-transparent element is placed within the intermediate cavity, it does not affect this optical mode, and the structure remains essentially transparent for this mode.

The above described design, where two cavities are essentially similar, and have the same dispersion law and are thus at resonance at all wavelengths, and one cavity is at resonance with those two only at a discrete selective wavelength or at a few discrete selective wavelengths, is rather robust. The two curves,

$$\begin{matrix}{ϑ}^{eff} = {ϑ}_{1}^{eff} ( λ ) , \\ and & ( 27 a ) \\ {ϑ}^{eff} = {ϑ}_{2}^{eff} ( λ ) , & ( 27 b )\end{matrix}$$

intersect at some point λ=λ*. If parameters of the fabricated structure deviate from the designed ones, due to fluctuations and uncertainties in the fabrication process, the two curves intersect nevertheless, perhaps at a slightly different wavelength.

If all three cavities are different, and all three dispersion laws are different:

$${ϑ}_{1}^{eff} ( λ ) \neq {ϑ}_{2}^{eff} ( λ ) \neq {ϑ}_{3}^{eff} ( λ ) \neq {ϑ}_{1}^{eff} ( λ ) , \qquad ( 28 )$$

and all three curves are expected to intersect at one point at a wavelength λ, then deviations of parameters of the structure due to technological fluctuations and uncertainties may lead to a situation where the three curves no longer intersect at one point, which results in deterioration of the device performance.

The above considerations can be extended to a situation where the tunnel coupling between the first cavity and the second cavity, on the one hand, and between the second cavity and the third cavity, on the other hand, are not equal. Here, there still exists an eigenvector of the matrix, the second component of which is zero,

$$[ \begin{matrix}{E}_{0} & {V}_{12} & 0 \\ {V}_{12} & {E}_{0} & {V}_{23} \\ 0 & {V}_{23} & {E}_{0}\end{matrix} ] ⊗ \frac{1}{\sqrt{1 + {( \frac{{V}_{12}}{{V}_{23}} )}^{2}}} \vert \begin{matrix}1 \\ 0 \\ - \frac{{V}_{12}}{{V}_{23}}\end{matrix} 〉 = {E}_{0} \times \frac{1}{\sqrt{1 + {( \frac{{V}_{12}}{{V}_{23}} )}^{2}}} \vert \begin{matrix}1 \\ 0 \\ - \frac{{V}_{12}}{{V}_{23}}\end{matrix} 〉 . \qquad ( 29 )$$

Thus, a general feature of 3×3 matrices discussed above demonstrates that if the three cavities are at some wavelength of light at resonance, there exists an optical mode, which is zero in the middle cavity.

An Arbitrary Odd Number of Resonantly Coupled Cavities

An example from linear algebra concerning three coupled cavities may be extended over an arbitrary odd number of resonantly coupled cavities. Consider first a matrix 5×5, similar to that of Eq. (21),

$$[ \begin{matrix}{E}_{0} & V & 0 & 0 & 0 \\ V & {E}_{0} & V & 0 & 0 \\ 0 & V & {E}_{0} & V & 0 \\ 0 & 0 & V & {E}_{0} & V \\ 0 & 0 & 0 & V & {E}_{0}\end{matrix} ] . \qquad ( 30 )$$

A physical example related to this matrix is a structure including five cavities, where i) all five cavities are at a given wavelength at resonance, and ii) the tunnel coupling between each pair of neighboring cavities is equal.
A straightforward substitution shows that the vector

$$\frac{1}{\sqrt{3}} \vert \begin{matrix}1 \\ 0 \\ - 1 \\ 0 \\ 1\end{matrix} 〉 \qquad ( 31 )$$

is an eigenvector of the matrix (30) corresponding to the eigenvalue E₀,

$$[ \begin{matrix}{E}_{0} & V & 0 & 0 & 0 \\ V & {E}_{0} & V & 0 & 0 \\ 0 & V & {E}_{0} & V & 0 \\ 0 & 0 & V & {E}_{0} & V \\ 0 & 0 & 0 & V & {E}_{0}\end{matrix} ] ⊗ \frac{1}{\sqrt{3}} \vert \begin{matrix}1 \\ 0 \\ - \frac{{V}_{12}}{{V}_{23}} \\ 0 \\ \frac{{V}_{12} {V}_{34}}{{V}_{23} {V}_{45}}\end{matrix} 〉 = {E}_{0} \times \frac{1}{\sqrt{3}} \vert \begin{matrix}1 \\ 0 \\ - \frac{{V}_{12}}{{V}_{23}} \\ 0 \\ \frac{{V}_{12} {V}_{34}}{{V}_{23} {V}_{45}}\end{matrix} 〉 , \qquad ( 32 )$$

An important feature of this eigenvector is that all of its components with even numbers, i.e., the second and the fourth components are zero.

Similar to the case of three coupled cavities, a structure with five coupled cavities may be designed, and a non-transparent element may be placed in any cavity having an even number, or in both the second and the fourth cavities. Then the structure is transparent for one mode only.

If the structure is designed such that four cavities are at resonance at an arbitrary wavelength, and one is at resonance with the other four only at a selective wavelength, then the system is transparent only at this selective wavelength.

The above example can be extended to a general situation, where each pair of neighboring cavities has a coupling, not necessarily equal. Then there still exists an eigenvector of the matrix, the second and the fourth components of which are zero,

$$[ \begin{matrix}{E}_{0} & {V}_{12} & 0 & 0 & 0 \\ {V}_{12} & {E}_{0} & {V}_{23} & 0 & 0 \\ 0 & {V}_{23} & {E}_{0} & {V}_{34} & 0 \\ 0 & 0 & {V}_{34} & {E}_{0} & {V}_{45} \\ 0 & 0 & 0 & {V}_{45} & {E}_{0}\end{matrix} ] ⊗ \frac{1}{\sqrt{A}} \vert \begin{matrix}1 \\ 0 \\ - 1 \\ 0 \\ 1\end{matrix} 〉 = {E}_{0} \times \frac{1}{\sqrt{A}} \vert \begin{matrix}1 \\ 0 \\ - 1 \\ 0 \\ 1\end{matrix} 〉 . \qquad ( 33 )$$

where the normalization constant

$$A = 1 + {( \frac{{V}_{12}}{{V}_{23}} )}^{2} + {( \frac{{V}_{12} {V}_{34}}{{V}_{23} {V}_{45}} )}^{2} . \qquad ( 34 )$$

This important feature of a 3×3 and a 5×5 matrix can be extended over the matrices of an arbitrary odd rank (2n+1)×(2n+1). Consider first a matrix, where all of the elements on the secondary diagonal are equal,

$$[ \begin{matrix}{E}_{0} & V & 0 & ⋯ & 0 & 0 & 0 \\ V & {E}_{0} & V & ⋯ & 0 & 0 & 0 \\ 0 & V & {E}_{0} & ⋯ & 0 & 0 & 0 \\ ⋯ & ⋯ & ⋯ & ⋯ & ⋯ & ⋯ & ⋯ \\ 0 & 0 & 0 & ⋯ & {E}_{0} & V & 0 \\ 0 & 0 & 0 & ⋯ & V & {E}_{0} & V \\ 0 & 0 & 0 & ⋯ & 0 & V & {E}_{0}\end{matrix} ] . \qquad ( 35 )$$

A physical example related to this matrix is a structure, including (2n+1) cavities, where i) all (2n+1) cavities are at a given wavelength at resonance, and ii) the tunnel coupling between each pair of neighboring cavities is equal.
A straightforward substitution shows that the vector

$$\frac{1}{\sqrt{n + 1}} \vert \begin{matrix}\begin{matrix}\begin{matrix}\begin{matrix}\begin{matrix}\begin{matrix}1 \\ 0\end{matrix} \\ - 1\end{matrix} \\ ⋯\end{matrix} \\ {( - 1 )}^{n - 1}\end{matrix} \\ 0\end{matrix} \\ {( - 1 )}^{n}\end{matrix} 〉 , \qquad ( 36 )$$

is an eigenvector of the matrix (32) corresponding to the eigenvalue E₀,

$$[ \begin{matrix}{E}_{0} & V & 0 & … & 0 & 0 & 0 \\ V & {E}_{0} & V & … & 0 & 0 & 0 \\ 0 & V & {E}_{0} & … & 0 & 0 & 0 \\ … & … & … & … & … & … & … \\ 0 & 0 & 0 & … & {E}_{0} & V & 0 \\ 0 & 0 & 0 & … & V & {E}_{0} & V \\ 0 & 0 & 0 & … & 0 & V & {E}_{0}\end{matrix} ] ⊗ \frac{1}{\sqrt{n + 1}} \vert \begin{matrix}\begin{matrix}\begin{matrix}\begin{matrix}\begin{matrix}\begin{matrix}1 \\ 0\end{matrix} \\ - 1\end{matrix} \\ ⋯\end{matrix} \\ {( - 1 )}^{n - 1}\end{matrix} \\ 0\end{matrix} \\ {( - 1 )}^{n}\end{matrix} 〉 = {E}_{0} \times \frac{1}{\sqrt{n + 1}} \vert \begin{matrix}\begin{matrix}\begin{matrix}\begin{matrix}\begin{matrix}\begin{matrix}1 \\ 0\end{matrix} \\ - 1\end{matrix} \\ ⋯\end{matrix} \\ {( - 1 )}^{n - 1}\end{matrix} \\ 0\end{matrix} \\ {( - 1 )}^{n}\end{matrix} 〉 . \qquad ( 37 )$$

A key feature of this eigenvector is that all components having even numbers are zero.

Similar to the above examples of 3×3 and 5×5 matrices, a general case of a (2n+1)×(2n+1) matrix can be created where elements on the secondary diagonals are not necessarily equal. In this case, there still exists an eigenvector, all elements of which with even numbers are zero, like in Eqs. (25) and (29).

A physical system is then a system of (2n+1) cavities, all of which are at some wavelength of light, at resonance. An optical mode of the system exists where the electric field vanishes in the second, fourth, and so on, in every cavity with an even number.

Similar to the example with three or five coupled cavities, a structure with (2n+1) coupled cavities may be designed, where a non-transparent element is placed in one cavity having an even number. In an alternative embodiment, a few non-transparent elements are placed in a few cavities having different even numbers. In yet another embdiment, non-transparent elements are placed in all of the cavities with even numbers. In all of these embodiments, the structure is transparent, at one selective wavelength, for only one optical mode.

If the structure is designed such that 2n cavities are at resonance at an arbitrary wavelength, and one is at resonance with the other 2n only at a selective wavelength, then the system is transparent only at this selective wavelength.

Filter Incorporating Three Coupled Cavities: Tilted Cavity Laser in the Edge-Emitting Geometry

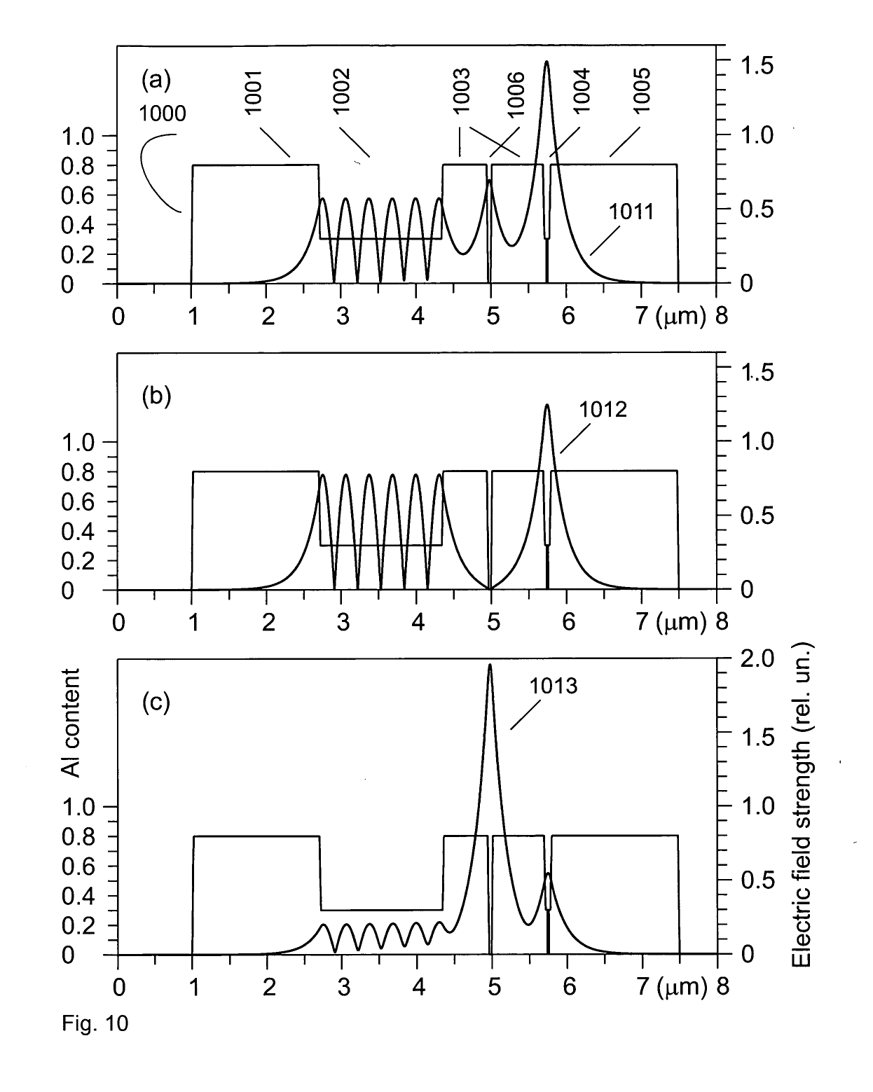

In another embodiment of the present invention, a non-transparent element is placed within a third cavity, the whole structure thus effectively having three cavities. FIG. 10 shows three optical modes in a structure of three coupled cavities, where an absorbing element is placed within the middle cavity. FIG. 10(a) shows the structure including three cavities. The electric field strength is shown in relative units. As an example, the structure is preferably a multilayered GaAlAs-based structure (1000) including an n-doped first evanescent reflector (1001), an n-doped first cavity (1002), an n-doped second evanescent reflector (1003), a second cavity (1004), and a p-doped third evanescent reflector (1005). A non-transparent element in this example is an absorbing element (1006) inserted into the second evanescent reflector. In particular, the absorbing element is preferably a layer of GaAs, which absorbs light with a wavelength below 870 nm, and has a refractive index higher than that of the second evanescent reflector (1003). The absorbing element may therefore be regarded as a third cavity. A semiconductor diode laser may be designed based on this structure, where the active layers (preferably quantum wells) are placed in the second cavity (1004).

The laser structure of FIG. 10(a) effectively has three coupled cavities, which results in three resonant modes extended over three cavities. FIGS. 10(a), (b), and (c) show the three modes (1011), (1012), and (1013), respectively. One of the three modes (1012) has a node at the middle cavity, which ensures extremely low losses for this mode, which agrees with the properties of the 3×3 matrix corresponding to three resonantly coupled cavities discussed above.

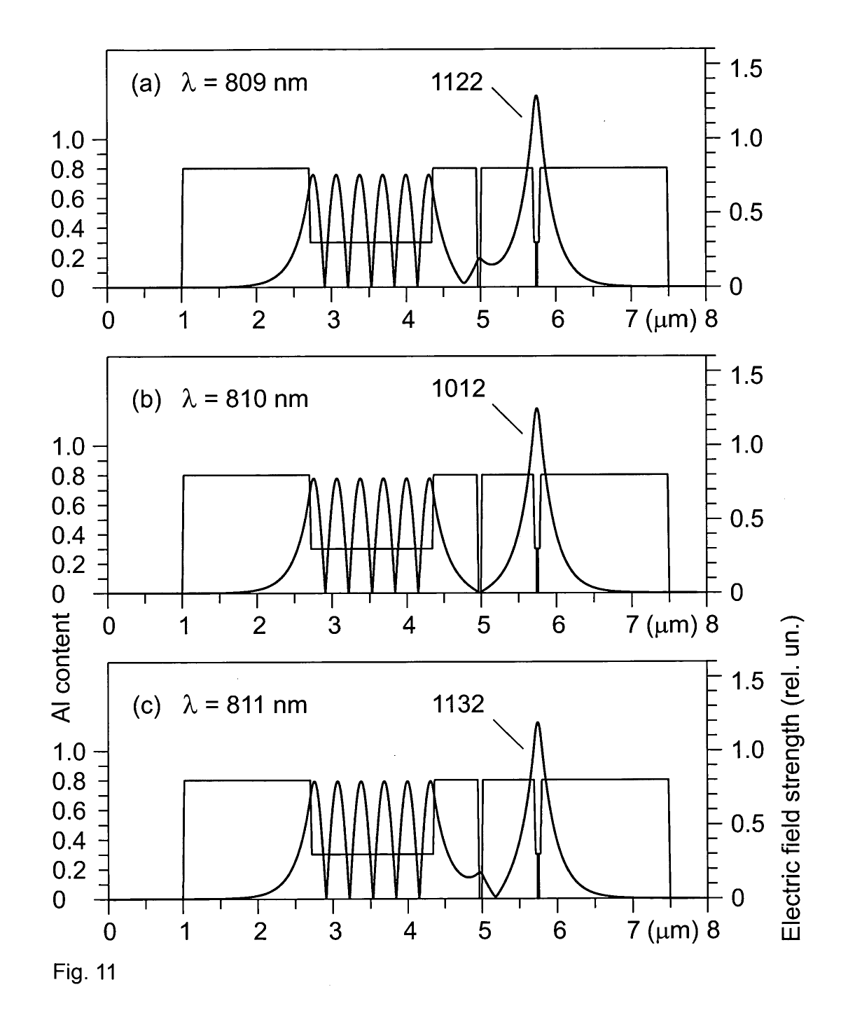

FIG. 11 shows the same structure as FIG. 10, with the optical mode, which has the minimum electric field strength from the three resonating optical modes, at three different wavelengths. FIGS. 11(a) through (c) show the optical mode, having the minimum losses among three coupled modes, as a function of the wavelength of light. FIG. 11(b) shows the optical mode (1012) at the resonance wavelength of 810 nm, where the mode has a clear node at the absorbing element. FIG. 11(a) shows the optical mode (1122) at a wavelength of 809 nm, where the electric field strength has a significant value at the absorbing element. FIG. 11(c) shows the optical mode (1132) at a wavelength of 811 nm, where the electric field strength again has a significant value at the absorbing element. Such behavior implies that the absorption losses of the optical mode can be extremely wavelength-selective.

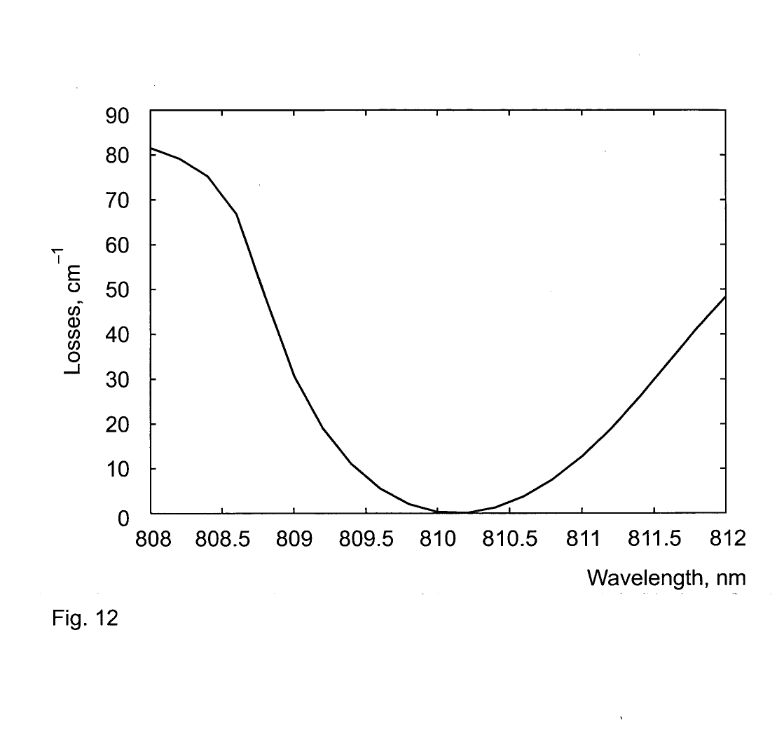

FIG. 12 shows the absorption losses of the resonant optical mode as a function of the wavelength of light thus showing an extremely narrow spectral interval, where the absorption losses are small, for example below 10 cm⁻¹, and lasing is possible.

Similar filters can be used as resonant optical amplifiers, where the device operates as an amplifier only in a narrow spectral region, where the resonant optical mode has low losses.

In another embodiment of the present invention, this filter is used in a resonant cavity photodetector. At a resonant wavelength, the absorption of light in all elements of the device other than the photodetecting element, which includes a p-n junction under a reverse or zero bias, are suppressed, and the absorption at the photodetecting element will be maximum resulting in the maximum value of the photocurrent.

Filter Incorporating Three Coupled Cavities: Tilted Cavity Surface Emitting Laser

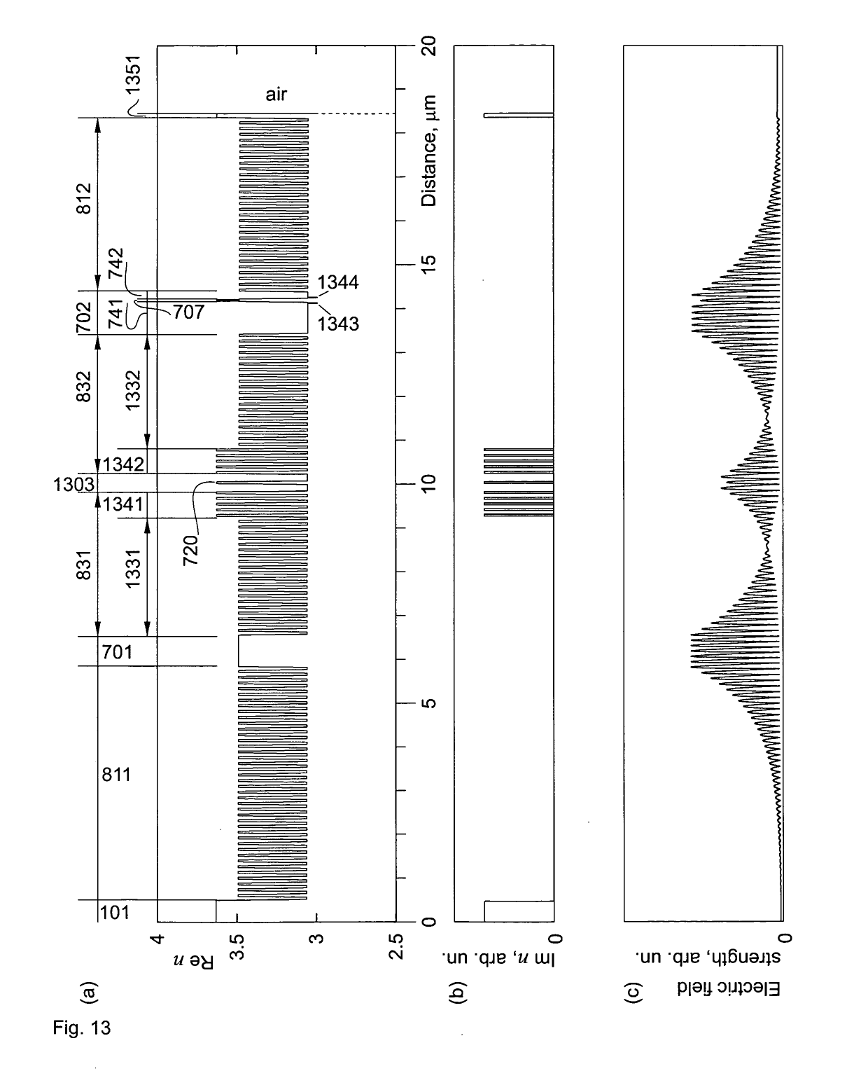

While the tilted cavity laser (TCL) described in the previous embodiment operates as an edge-emitting laser, in another embodiment, the tilted cavity laser incorporating an interference filter operates as a tilted cavity surface-emitting laser (TCSEL). FIGS. 13 through 17 refer to an example of a TCSEL incorporating an interference filter. The laser is designed to emit laser light at the wavelength of 850 nm in a tilted optical mode tilted at an angle of 6 degrees with respect to the direction normal to the p-n junction plane. The angle is defined in a reference layer Ga_{0.8}Al_{0.2}As which is transparent for light at 850 nm.

FIGS. 13 through 15 show a structure of a tilted cavity surface emitting laser incorporating an interference filter and having three resonating optical modes in the structure. FIG. 13(a) shows the spatial profile of the real part of the refractive index. The laser structure grown epitaxially on a GaAs substrate (101) includes a preferably n-doped first multilayered interference reflector (MIR) (811), a preferably n-doped first (passive) cavity (701), a preferably n doped second MIR (831), a second preferably n-doped (absorbing) cavity (1303), a preferably n-doped third MIR (832), a third (active) cavity (702), a preferably p-doped fourth MIR (812), and a preferably p-doped contact layer (1351). The absorbing element includes one or a few layers of GaAs, which absorb light at 850 nm. In a preferred embodiment, there is one thick GaAs layer, which eliminates the possible effects of quantization of electronic spectrum and the shift of the absorption edge towards higher photon energies. The absorbing element also includes a layer (720) within the second cavity (1303), a few GaAs layers in the absorbing part (1341) of the second MIR (831), and a few GaAs layers in the absorbing part (1342) of the third MIR (832). The number of absorbing layers preferably does not exceed one third of the total number of layers in the MIR, to keep the absorption losses of the resonant optical mode low.

Thus, the second MIR (831) includes a transparent part (1331) and an absorbing part (1341). The third MIR (832) includes an absorbing part (1342) and a transparent part (1332). Transparent parts of all of the MIRs are preferably formed of alternating layers of Ga₁₋ₓAlₓAs with alternating aluminum composition. In one embodiment, the layers are effective λ/4-layers for the chosen angle of propagation of the tilted mode. Absorbing parts of the MIRs are preferably formed of alternating layers of GaAs/GaAlAs. The absorbing element (720) within the cavity (1303) is preferably formed of GaAs.

The active cavity (702) includes an n-doped layer (741), an active region (707), and a p-doped layer (742). The active region (707) is sandwiched between a first current aperture (1343) and a second current aperture (1344). The current apertures are preferably formed from (Ga)AlO layers obtained by the oxidation of Ga₁₋ₓAlₓAs layers with high aluminum content, preferably x>0.93. The active region preferably includes a few quantum wells separated by GaAlAs barriers. The quantum wells are preferably formed of GaAs or GaAlAs and designed such to emit light at the desired wavelength (for this embodiment 850 nm).

FIG. 13(b) shows the imaginary part of the dielectric function proportional to the absorption coefficient of light. The absorbing element in the middle of the structure includes 11 GaAs layers. In addition, the GaAs substrate and the GaAs contact layer are absorbing. The major contribution comes from the interband absorption of light in the layers of GaAs in the absorbing element, in the substrate, and in the top p-contact layer.

The structure includes effectively three cavities, where the second and the third cavity include thin layers of GaAs and/or Ga_{0.8}Al_{0.2}As sandwiched between layers of high aluminum content Ga_{0.1}Al_{0.9}As. The first cavity is a thick 3λ-cavity of low aluminum content Ga_{0.8}Al_{0.2}As. Thus, when all three cavities are brought to a resonance, the second and the third cavities are at resonance or close to resonance in a broader spectral region, while the first cavity quickly goes off resonance upon a small change in the wavelength.

At a resonance wavelength, the system has three tilted optical modes extended over all three cavities. FIG. 13(c) shows the absolute value of the electric field strength, which is a complex value, for the first of the three modes. This first mode has significant value of the electric field strength at the absorbing element, which implies essential absorption losses.

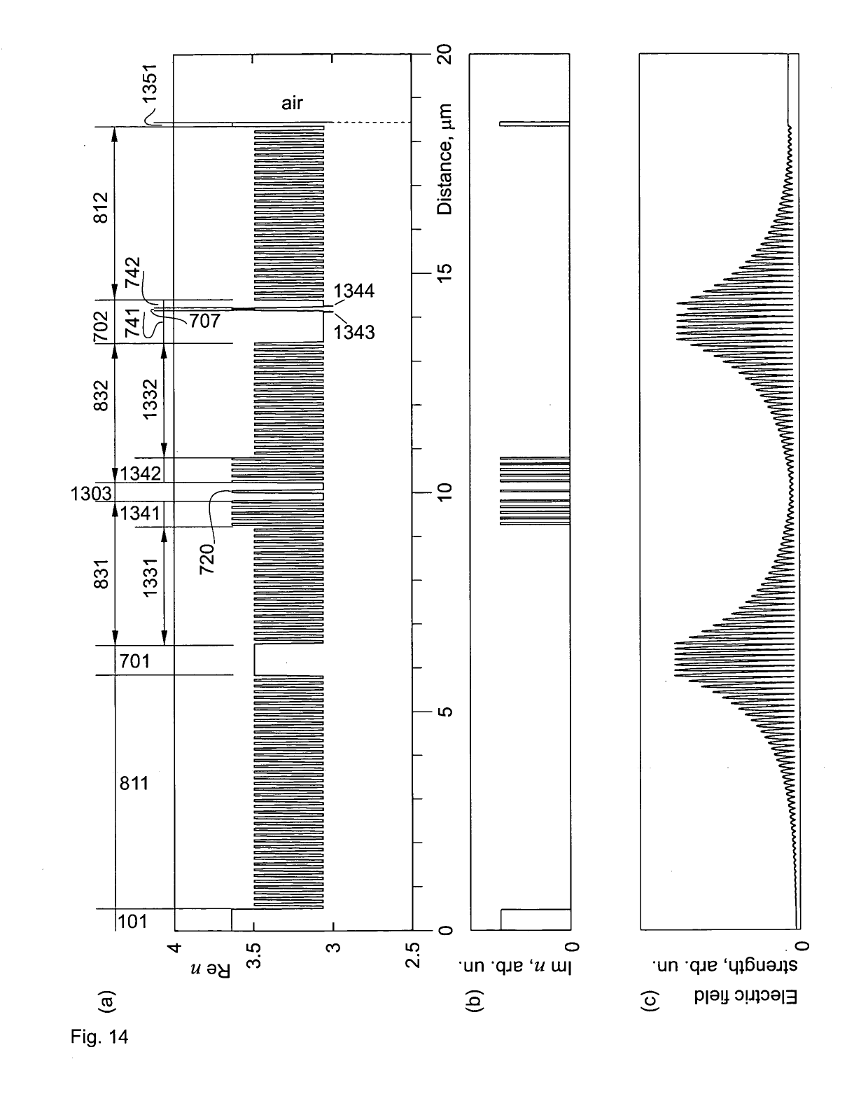

FIGS. 14(a) through (c) show the refractive index profile in the structure and the second resonating optical mode. FIG. 14(c) shows the second tilted optical mode extended over three cavities. This mode has an extremely low electric field strength at the absorbing element.

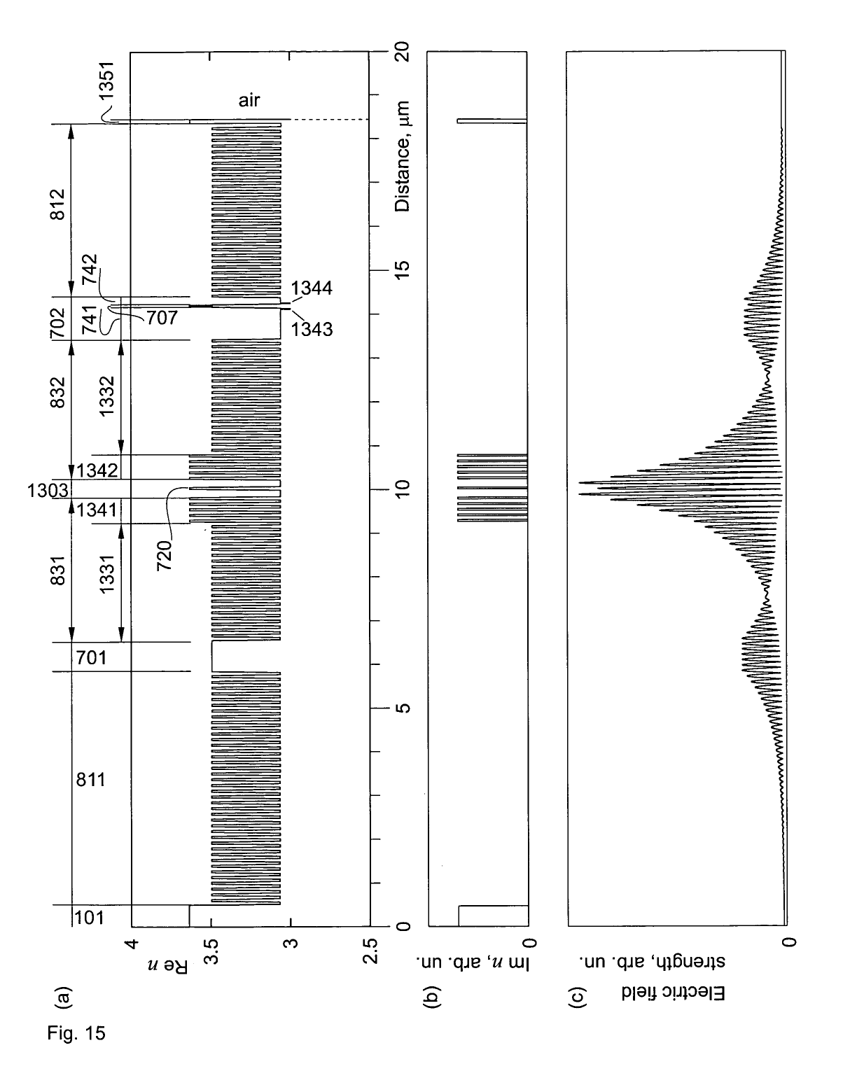

FIGS. 15(a) through (c) show the refractive index profile in the structure and the third resonating optical mode. FIG. 15(c) shows the third tilted optical mode extended over three cavities. This mode has an even larger electric field strength at the absorbing element than the first mode of FIG. 13(c).

Thus, the structure of three coupled cavities reveals at the resonance wavelength three tilted optical modes, each of which is extended over three cavities. One of the three modes has nearly zero intensity in the middle cavity of the three cavities, which agrees with the features of specific matrices discussed above. As an absorbing element is placed within the middle cavity, it results in a very small absorption losses of the second mode of the three and in large absorption losses of the other modes.

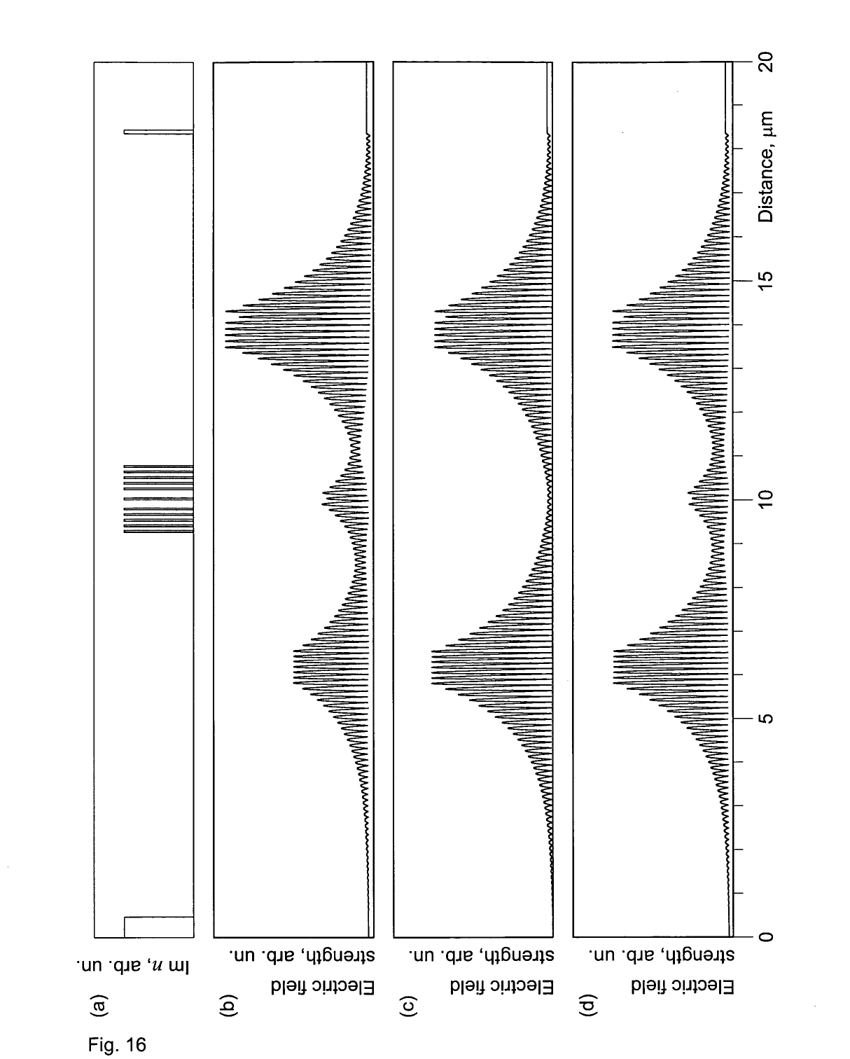

FIG. 16 shows the spatial profile of the “second” optical mode of the three resonating optical modes, where the second optical mode has the least losses out of the three modes. FIG. 16(a) through (d) show the structure and the profile of the optical mode, which has the minimum losses out of the three resonating optical modes, at three different wavelengths close to resonance. FIG. 16(a) repeats the spatial profile of the imaginary part of the dielectric function shown in FIGS. 13(b), 14(b), and 15(b). FIGS. 16(b), (c), and (d) show the absolute value of the electric field strength of the optical mode at the wavelengths of 848 nm, 850.5 nm, and 853 nm, respectively. The figures show that the intensity of the optical mode at the absorbing element is very low at resonance and increases rapidly as the wavelength shifts away from the resonance.

It is important to note that if reflectors used in an optoelectronic device are multilayer interference reflectors, as is the case for a TCSEL, the electric field oscillates in many optical modes, and many optical modes may have nodes at the absorbing element or close to it. An important feature of the resonance in this case is that an envelope function of one mode vanishes at the absorbing element or at least takes very small values. This is the case for the envelope function of the optical mode at FIG. 14(c), the same mode being also shown in FIG. 16(c). This allows the use of absorbing element that are not very thin, and also places parts of the absorbing elements in the parts of the MIRs surrounding the middle cavity.

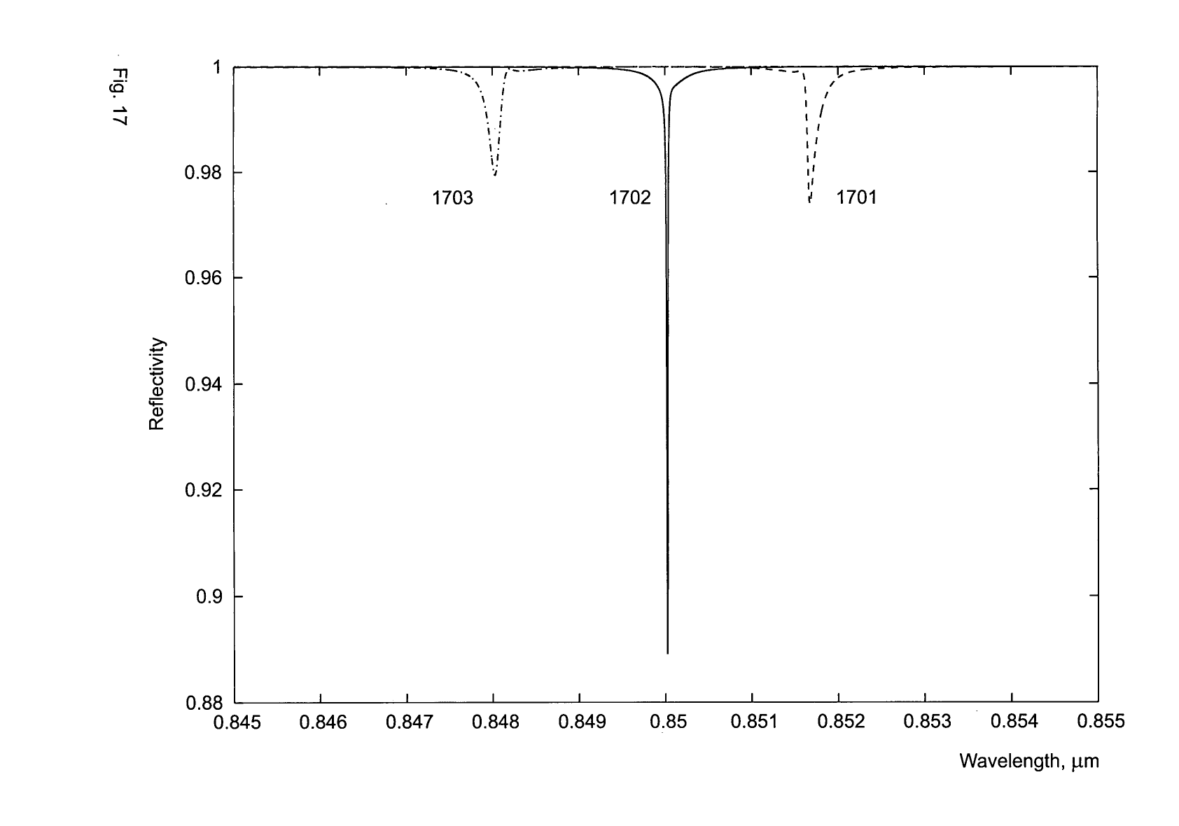

The losses of a tilted optical mode can be estimated from the reflectivity spectra of the structure calculated for tilted propagation of light. FIG. 17 shows the reflectivity spectra of the structure, when light impinges on the structure from the top from an infinite transparent medium Ga_{0.8}Al_{0.2}As at three angles. The structure reveals an extremely narrow dip at the resonant angle of 6 degrees, and considerably broader dips for angles off resonance, more specifically, angles of 5 and 7 degrees. A dashed curve (1701) shows the reflectivity at a 5 degree angle, the solid curve (1702) shows the reflectivity at a 6 degree angle, and the dashed-dotted line (1703) shows the reflectivity at a 7 degree angle. The full width at half minimum of the dip equals 0.12 nm (for 5 degrees), 0.013 nm (for 6 degrees), and 0.14 nm (for 7 degrees). The width of the dip is inversely proportional to the cavity finesses, or to the photon lifetime in the cavity. Thus, the cavity finesse turns out to be an extremely sharp function of the tilt angle (and of the wavelength of light).

Forming a Single-Lobe Versus a Multi-Lobe Beam

In one embodiment of the present invention, a tilted cavity surface emitting laser (TCSEL) incorporating an interference filter is designed such that a top metal contact is formed atop the topmost MIR. In addition, oxide current apertures are preferably made such that there is no injection current close to the side facets. Thus, light in the optical mode also does not come to the side facets and is not able to come out of the device through side facets. If there is no output aperture in the top contact, light does not come out.

If a small output aperture is made in the top contact, with a typical size D such that the size of the aperture is less than approximately a half of the effective wavelength in the direction of the lateral plane, i.e.

$$D < \frac{π}{\vert {k}_{x} \vert} = \frac{λ}{2 n sin ϑ} . \qquad ( 38 )$$

Then the outgoing laser light has a single-lobe far field pattern.

For the tilt angle θ=6°, and n=3.5, Eq. (38) yields the criterion D<1.4λ. For λ=850 nm, the criterion yields D<1.2 μm. For λ=1300 nm, this criterion yields D<1.8 μm.

On the other hand, if the size of the output optical aperture is larger than the approximate value

$$D > \frac{λ}{2 n sin ϑ} , \qquad ( 39 )$$

the outgoing laser light will have a multi-lobe far field pattern.

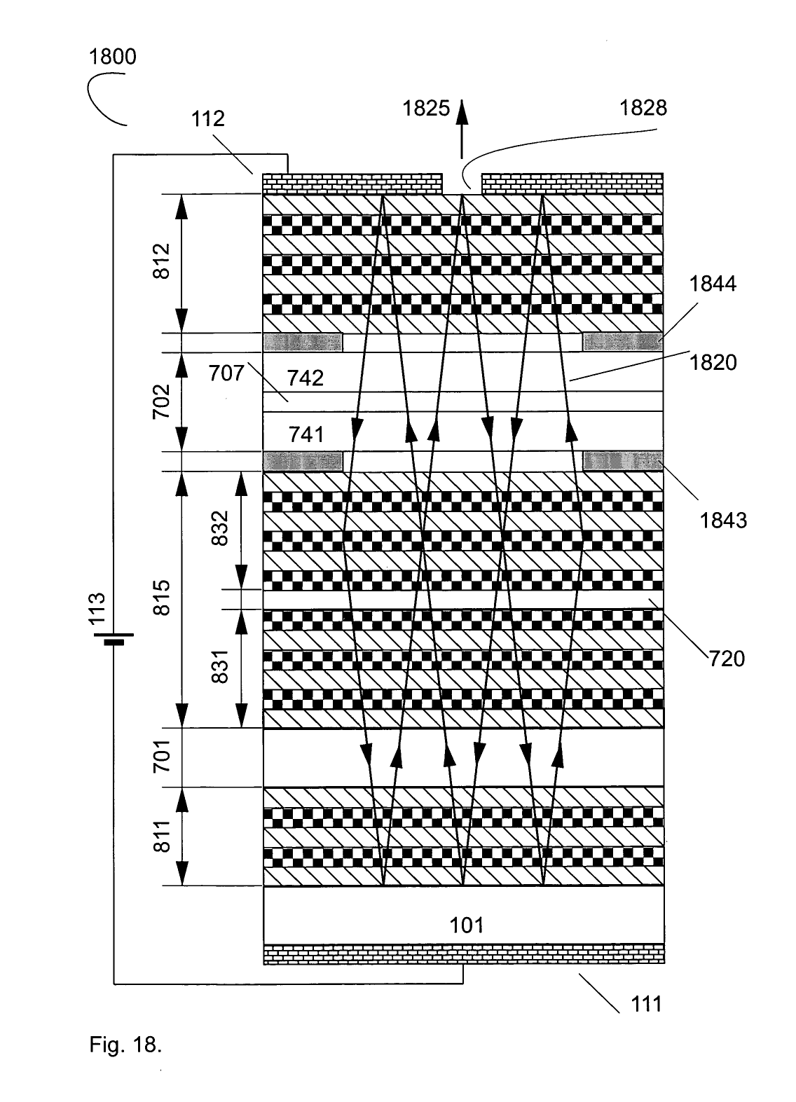

FIG. 18 shows a tilted cavity surface emitting laser (1800) incorporating an interference filter in an embodiment of the present invention. A narrow aperture (1828), which satisfies the approximate criterion of Eq. (38), is made in the top contact (112). A first oxide current aperture (1843) and a second oxide current aperture (1844) are also included in the structure. The laser light generated in the resonant tilted optical mode (1820) comes out (1825) and forms a single-lobe far field pattern.

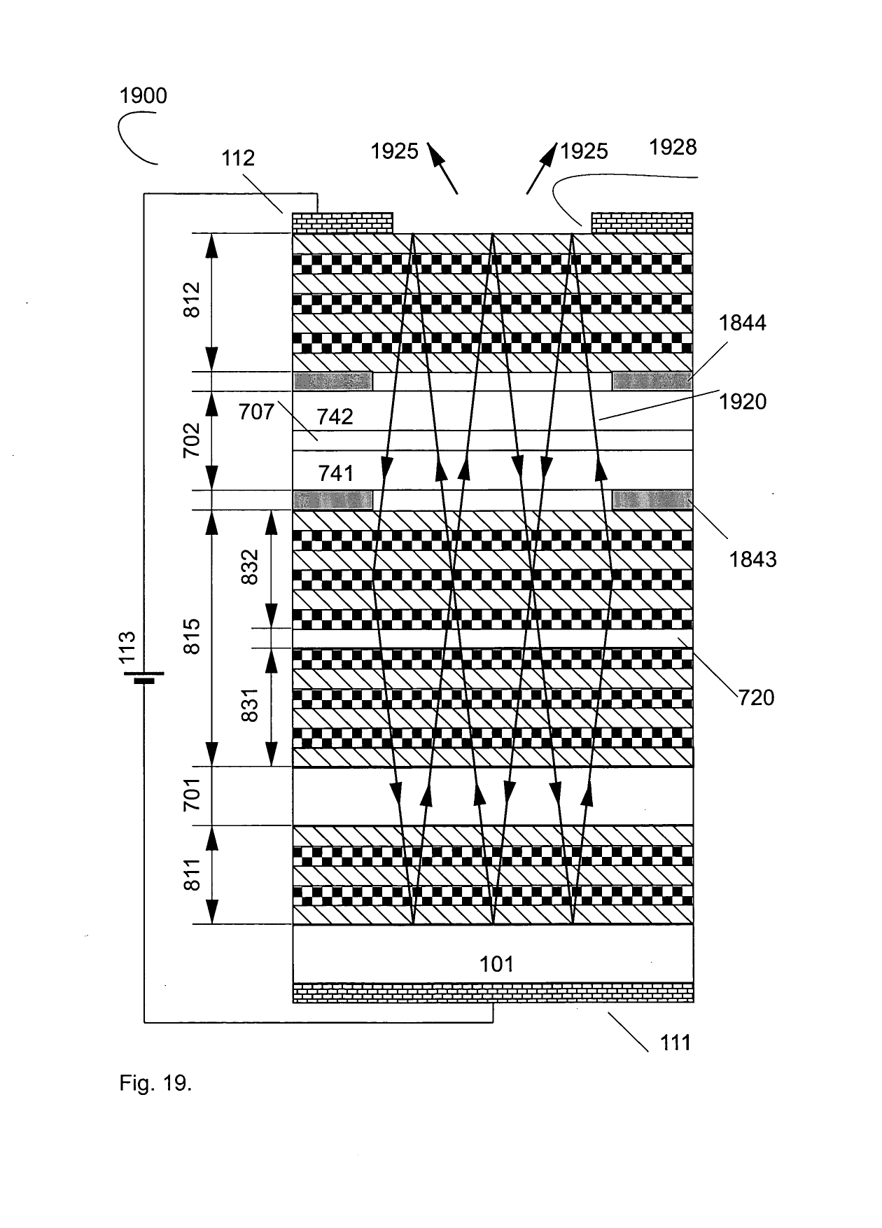

FIG. 19 shows a tilted cavity surface emitting laser (1900) incorporating an interference filter in another embodiment of the present invention. In this embodiment, a broad aperture (1928) is made in the top contact (112). This aperture (1928) satisfies the approximate criterion of Eq. (39). The laser light generated in the resonant optical mode (1920) comes out (1925) and forms a multi-lobe far field pattern.

It should be noted that having a narrow spectral region where the filter is transparent allows for the construction of TCSELs and vertical cavity surface emitting lasers with a wide output optical aperture that still operate in a single transverse mode. If the spectral distance between the neighboring transverse modes is larger than the transparency interval of the filter, the gain will overcome the losses for only one transverse mode ensuring the single-mode operation. This allows the use of wider optical apertures than in the prior art, thus designing single transverse mode high power VCSELs and TCSELs.

Wavelength-Tunable Laser Incorporating an Interference Filter

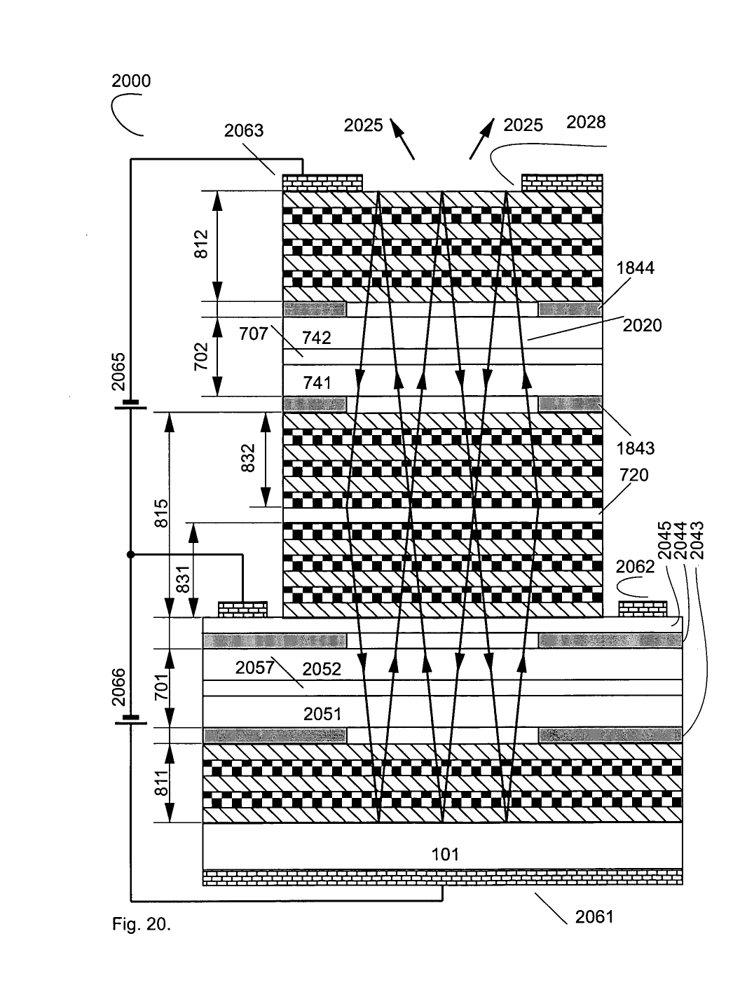

FIG. 20 shows a device according to another embodiment of the present invention. The device (2000) combines a tilted cavity surface emitting laser and an electrooptical modulator.

The device includes an n-doped substrate (101), an n-doped first multilayer interference reflector (MIR) (811), a first oxide current aperture (2043), a first cavity (701), a second oxide current aperture (2044), a p-doped current spreading layer (2045), a p-doped second MIR (815), in which an absorbing element (720) is introduced, a third oxide current aperture (1843), an active cavity (702), which includes an active region (707), a fourth oxide current aperture (1844), and an n-doped third MIR (812). A first n-contact (2061) is mounted on the bottom side of the substrate. An intracavity p-contact (2062) is mounted on the p-doped current spreading layer (2045). A second n-contact (2063) is mounted atop the third n-doped MIR (812). Laser light is generated in the resonant tilted optical mode (2020). Light comes out (2025) through the output optical aperture (2028). A forward bias (2065) is applied to the active region through the n-contact (2063) and the p-contact (2062).

A bias (2066) is applied to the first cavity (701) in this device. The cavity (701) includes an n-doped region (2051), a modulator region (2057), and a p-doped region (2052). The modulator region is preferably a structure including multiple quantum wells such that the exciton absorption peak of these quantum wells is at an energy higher than the photon energy corresponding to the wavelength of the emitted laser light. If the bias (2066) applied to the modulator region via the n-contact (101) and the p-contact (2062) is a reverse bias (as shown in FIG. 20), then the absorption peak of the quantum wells of the modulator region shifts to lower energies due to the Quantum Confined Stark Effect.

It should be noted that the real and imaginary parts of the dielectric function ε(E)=ε′(E)+iε″(E) are related through Kramers-Kronig relationship,

$${ɛ}^{′} ( E ) = {ɛ}_{0} + \frac{1}{π} P \int \frac{{ɛ}^{″} ( {E}^{′} )}{{E}^{′} - E} ⅆ {E}^{′} , \qquad ( 40 )$$

where ε₀ is a non-resonant contribution, and P stands for the principal value of the integral. Therefore, a spectral shift of the absorption peak results in a change of the real part of the dielectric function of the modulator region. Then, it shifts resonance conditions, and the resonance optical mode having the minimum losses occurs at a different photon energy, i.e., at a different wavelength. Thus, by applying a reverse bias to the modulator cavity, it is possible to shift the wavelength of laser light emitted by the device.

In an alternative embodiment of the present invention, the modulator cavity operates under a forward bias, and the refractive index of the modulator region is varied due to the effect of bleaching.

In another embodiment of the present invention, two or three contacts are made as intracavity contacts. In yet another embodiment, four intracavity contacts may be used, where a pair of contacts is placed around the active cavity, and another pair of contacts is placed around the modulating cavity. In these embodiments, some or even all of the MIRs are formed undoped.

Although FIG. 20 shows a wavelength-tunable TCSEL, the similar construction of a wavelength-tunable VCSEL operating in a vertical optical mode is also embodied by the present invention.

In the above described embodiments of wavelength-tunable VCSELs or TCSELs, the modulator element includes a p-n junction, and a bias is applied via one n-contact and one p-contact. In an alternative embodiment, the modulator is an undoped semiconductor structure including modulator layers, and the electric field is applied via two n-contacts. Thus the structure of a modulator element is an n-1-n structure where “i” states for “intrinsic”, or undoped semiconductor. In yet another embodiment, a modulator element can be realized as a p-1-p structure, where the electric field is applied via two p-contacts.

Electrooptical Intensity Modulator

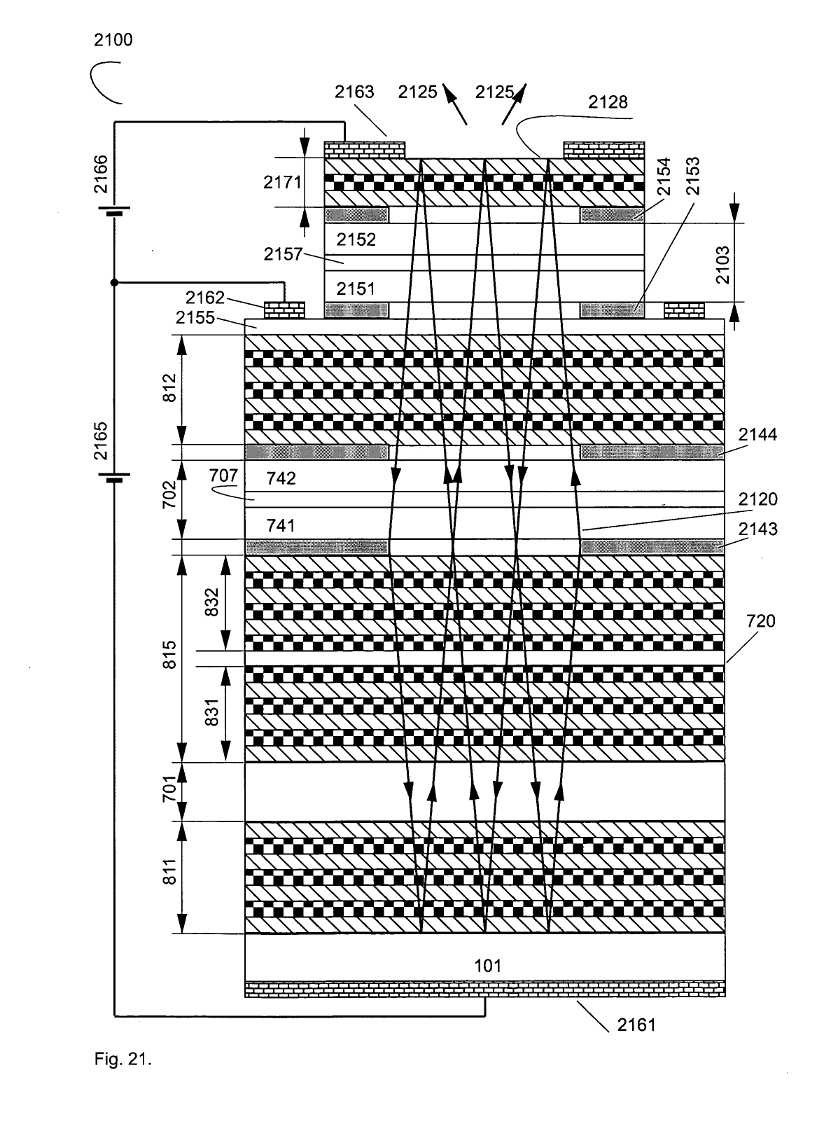

FIG. 21 shows a device according to another embodiment of the present invention. A tilted cavity surface emitting laser (2100) incorporating an interference filter is combined with a modulator element in a different way than in the device (2000) of FIG. 20. The TCSEL element of FIG. 21 is basically the same as the device (900) described in FIG. 9. The device is grown epitaxially on an n-doped substrate (101), and includes a first multilayer interference reflector (811), an n-doped first cavity (701), an n-doped second MIR (815), into which an absorbing element (720) is introduced, a second (active) cavity (702), sandwiched between a first oxide current aperture (2143) and a second oxide current aperture (2144), and a p-doped third MIR (812).

The device (2100) also includes a modulating element. A p-doped current spreading layer (2155) is grown on top of the third MIR (812). A first n-contact (2161) is mounted on the bottom side of the substrate (101), and an intracavity p-contact (2162) is mounted on the p-doped current spreading layer (2155). A forward bias (2165) is applied to the active region (707) via the first n-contact (2161) and the intracavity p-contact (2162).

The modulator element also includes a third oxide current aperture (2153), a modulator cavity (2103), a fourth oxide current aperture (2154), and a fourth MIR (2171). The modulator cavity (2103) includes a p-doped region (2151), a modulator region (2157), and an n-doped region (2152). The modulator region (2157) preferably includes multiple quantum wells, the exciton absorption edge of which is at an energy larger than the photon energy corresponding to the wavelength of laser light. The modulator element operates preferably under a reverse bias (2166). The bias is applied to the modulator region via the intracavity p-contact (2162) and the second n-contact (2163) mounted on top of the fourth MIR (2171).

The fourth MIR (2171) is preferably designed such that it has a weaker reflectivity at the optimum tilt angle and the optimum wavelength corresponding to the resonance tilted optical mode than the first MIR (811), the second MIR (815), and the third MIR (812). This can be achieved by employing a fewer number of pairs of layers with alternating refractive indices in the fourth MIR (2171) than in other MIRs. Thus, the modulator cavity (2103) has by itself a rather low finesse. So, there is no optical mode originating from this cavity alone. At a resonant wavelength, the optical eigenmodes of the system are linear combinations of the modes originating either from the two cavities, (701) and (702), or from three cavities, if the absorbing element (720) is a cavity by itself. There is one mode having very low absorption losses, and these low losses are achieved only at a selective wavelength.

Varying the refractive index of the modulator cavity may then influence the intensity of the outgoing laser light (2125) which comes out through the modulator element, and, finally, through the output optical aperture (2128). If the refractive index of the modulator region (2157) is such that the cavity (2103) is at resonance with the other cavities, then a part of the optical power of the resonance optical mode (2120) shifts from the rest of the structure to the cavity (2103). Correspondingly, the intensity of the output light (2125) increases. If the cavity (2103) is out of resonance with the other cavities, the intensity of the output light (2125) decreases.

In another embodiment of the present invention, an electrooptical intensity modulator operates on a vertical optical mode, thus combining a VCSEL and a modulator element.

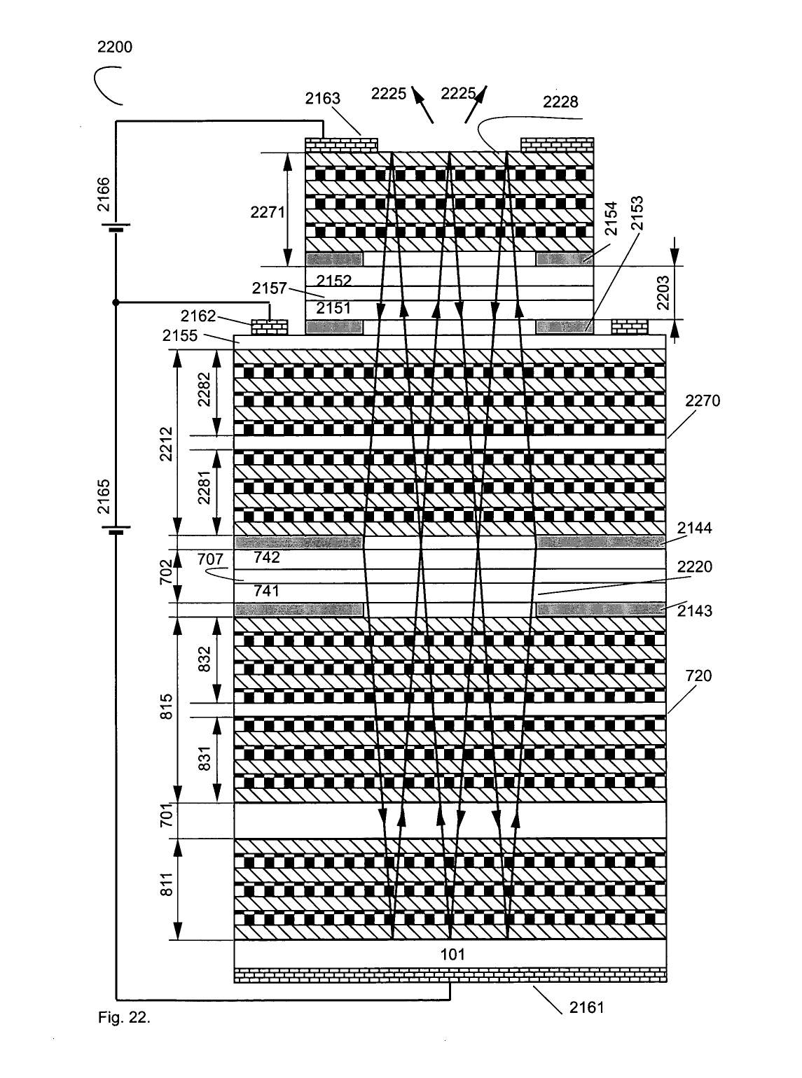

In another embodiment of the present invention, a TCSEL combined with a modulator switches on and off lasing completely. FIG. 22 shows an optoelectronic device (2200) according to this embodiment of the present invention. The tilted cavity surface emitting laser incorporating an interference filter includes five cavities. The structure, grown epitaxially on an n-doped substrate (101), includes an n-doped first multilayer interference reflector (MIR) (811), an n-doped first cavity (701), an n-doped second MIR (831), an n-doped second cavity (720) containing a first absorbing element, an n-doped third MIR (832), an active cavity (702), a p-doped fourth MIR (2281), a p-doped fourth cavity (2270) containing a second absorbing element, a p-doped fifth MIR (2282), a p-doped current spreading layer (2155), a fifth (modulator) cavity (2203), and an n-doped sixth MIR (2271). The effective reflector (2212) between the active cavity (702) and the modulator cavity (2203) includes two MIRs, (2281) and (2282), and a cavity (2270) with an absorbing element between these two MIRs.

By applying preferably a reverse bias (2166) to the modulator region (2157), it is possible to change the refractive index of the modulator region, and thus, the effective refractive index of the modulator cavity (2203). At one state of the modulator, the refractive index of the modulator cavity is such that all five cavities can be brought to a resonance at a certain wavelength. Then, according to the above considered properties of specific 5×5 matrices, there exists an optical eigenmode of the system, where the electric field strength vanishes in both the second cavity (720) and the fourth cavity (2270). This optical mode is insensitive to two absorbing elements. This mode has low losses, which allows the lasing of the laser. The laser light generated in a tilted optical mode (2220) comes out (2225) through the optical aperture (2228).

At another state of the modulator, the refractive index of the modulator cavity (2203) is such that all five cavities at any wavelengths do not come to resonance altogether. Therefore, at any wavelength of light, all optical modes necessarily have high absorption losses, and the lasing is suppressed.

Multiple Color Filter

A multiple color filter, which provides the opportunity to separate colors, including colors which are relatively close in wavelength, at different clearly distinguishable angles can be useful in numerous applications. For example, this filter can be used in stereoscopic 3D displays, including stereoscopic television displays. In a stereoscopic display, two component images of the single stereoscopic image are usually positioned on a same surface, for example being separated in alternating stripes.

In the existing displays, a transparent dielectric curved grating with a period identical to the stripe periodicity is attached to the image in such a way that the image taken for the left eye is deflected to the left, and the image, taken for the right eye, is deflected to the right. (discussed in Annual Report of Heinrich Hertz Institute, 2003, http://www.hhi.fraunhofer.de/english/, herein incorporated by reference).

The angles are chosen such that the two different images approach two different eyes separately giving a resulting 3D image. In the current invention, image separation is achieved by angle separation of the interference filter. First, the situation for only one color, for example, green, is considered. Assume that there are two green colors separated in wavelength, for example blue-green and yellow-green. These colors can be separated in angle in a way that the one of the colors come to the left eye and the other comes to the right eye giving a 3D green image composed of green-yellow and green-blue. A similar approach can be realized for the red and for the blue stereoscopic channels, in the latter case resulting in a full-color 3D image.

Improvement of the Efficiency of Light Source with a Broad Emission Spectrum

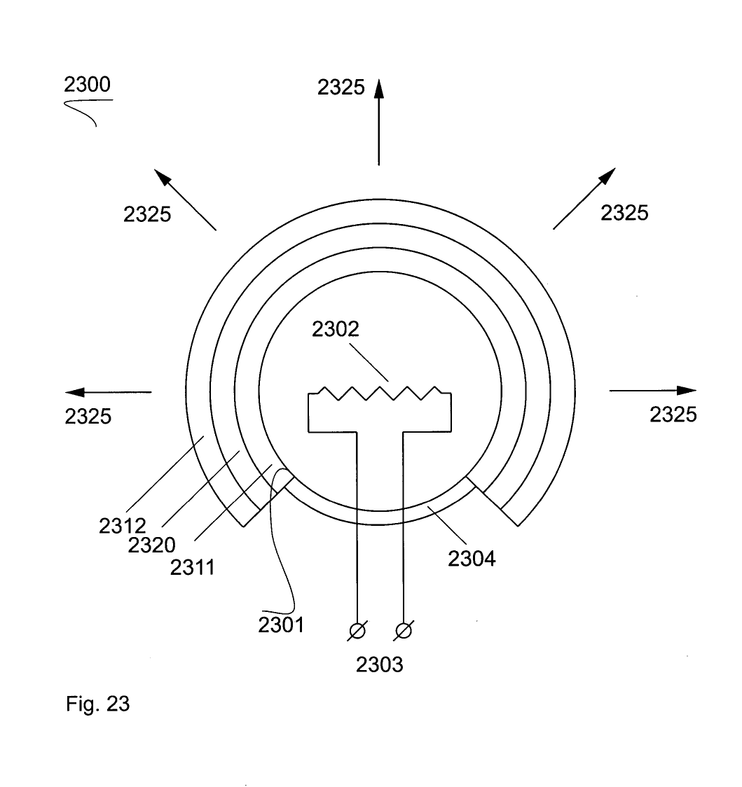

An interference filter disclosed in the present invention can be employed to improve efficiency of light sources emitting light in a broad spectrum. FIG. 23 shows a device (2300), which is a light bulb incorporating the interference filter. The device includes a glass bulb (2301). An alternating voltage is applied (2303) to the filament (2302), resulting in an alternating current through the filament and heating of the filament. The heated filament emits light in a broad spectrum. Part of the light is reflected back to the filament by the metallic reflector (2304). A novel element of the device is an interference filter, which includes a first dielectric cavity (2311), a reflecting element (2320), and a second dielectric cavity (2312). The dielectric cavities are preferably formed from single-layered or multi-layered dielectric structures. The reflecting element (2320) is preferably formed from a metallic reflector. The cavities and the reflecting element (2320) are designed such that the optical modes at a certain wavelength have a node at the reflecting element (2320). These modes can be effectively transmitted through the filter, whereas light at different wavelengths is reflected back to the filament. Accumulation of the electromagnetic radiation at the filament results in additional heating of the filament. Output light (2325) is light in a narrow spectral range where the filter transmits light.

Thus, if a light source emitting a broad spectrum, e.g. an incandescent lamp, or a halogen lamp, is used to obtain light in a narrow spectral range, using an interference filter allows receiving light at a given output power by applying a smaller electric power. Losses due to emission of light in undesired spectral range are efficiently suppressed.

Although the invention has been illustrated and described with respect to exemplary embodiments thereof, it should be understood by those skilled in the art that the foregoing and various other changes, omissions and additions may be made therein and thereto, without departing from the spirit and scope of the present invention. Therefore, the present invention should not be understood as limited to the specific embodiments set out above but to include all possible embodiments which can be embodied within a scope encompassed and equivalents thereof with respect to the features set out in the appended claims.

1. An optoelectronic device comprising an interference filter, wherein the interference filter comprises:
a) a first reflector;
b) a second reflector;
c) a third reflector;
d) a first optical cavity located between the first reflector and the second reflector; wherein:
i) the first optical cavity localizes at least one optical mode;
ii) a first optical mode localized by the first optical cavity decays away from the first optical cavity in the first reflector and in the second reflector; and
iii) an effective first angle of propagation of the first optical mode as a function of a wavelength of light follows a first dispersion law;
e) a second optical cavity located between the second reflector and the third reflector; wherein:
i) the second optical cavity localizes at least one optical mode;
ii) a second optical mode localized by the second optical cavity decays away from the second optical cavity in the second reflector and in the third reflector;
iii) an effective second angle of propagation of the second optical mode as a function of the wavelength follows a second dispersion law; and
iv) the second dispersion law is different from the first dispersion law;
wherein the first reflector is located on a side of the first optical cavity remote from the second optical cavity;
wherein the second reflector is located between the first optical cavity and the second optical cavity;
wherein the first optical cavity and the second optical cavity are at resonance; wherein the resonance occurs at at least one discrete wavelength of light, wherein:
i) the effective first angle of propagation of the first optical mode matches with the effective second angle of propagation of the second optical mode; and
ii) optical eigenmodes of the system comprise:
A) a third optical mode, which is a first linear combination of the first optical mode and the second optical mode and is extended over both the first optical cavity and the second optical cavity; and
B) a fourth optical mode, which is a second linear combination of the first optical mode and the second optical mode and is extended over both the first optical cavity and the second optical cavity;
wherein the second linear combination is different from the first linear combination;
wherein the third optical mode has a zero intensity at a node positioned in the second reflector between the first optical cavity and the second optical cavity; and
wherein a position of the node changes as a function of a wavelength of light; and
f) a non-transparent element, wherein the non-transparent element is placed within the second reflector such that:
i) the position of the node of the third optical mode matches with a position of the non-transparent element at at least one discrete wavelength of light such that the device at resonance is transparent to the third optical mode;
ii) the optical modes different from the third optical mode have a non-vanishing intensity at the non-transparent element, such that the device is not transparent to the optical modes different from the third optical mode; and
iii) when the system is off resonance, the position of the node of the third optical mode differs from the position of the non-transparent element, and the device is therefore not transparent to any of the optical modes;
such that the optoelectronic device operates as a wavelength-selective optoelectronic device.

2. The optoelectronic device of claim 1, wherein the at least one discrete wavelength is one discrete wavelength.

3. The optoelectronic device of claim 1, wherein the at least one discrete wavelength is a few discrete wavelengths.

4. The optoelectronic device of claim 1, wherein the angle of propagation of light for optical modes is defined with respect to a chosen reference frame for the optoelectronic device and within a reference layer of the device.

5. The optoelectronic device of claim 1, wherein the non-transparent element is selected from the group consisting of:
a) an absorbing element;
b) a scattering element; and
c) a reflecting element.

6. The optoelectronic device of claim 5, wherein the non-transparent element is an absorbing element; and
a) the third optical mode at resonance occurring at at least one first discrete wavelength has low absorption losses;
b) the other optical modes at resonance occurring at at least one second discrete wavelength have high absorption losses; and
c) all optical modes off resonance have high absorption losses;
wherein the low absorption losses are smaller than any of the high absorption losses by at least a factor of five.

7. The optoelectronic device of claim 5, wherein the non-transparent element is a scattering element; and
a) the third optical mode at resonance occurring at at least one first discrete wavelength has low losses due to scattering;
b) the other optical modes at resonance occurring at at least one second discrete wavelength have high losses due to scattering; and
c) all optical modes off resonance have high losses due to scattering;
wherein low losses due to scattering are smaller than any high losses due to scattering at least by a factor of five.

8. The optoelectronic device of claim 5, wherein the non-transparent element is a reflecting element; and
a) a first transmission coefficient of the device at resonance, occurring at at least one first discrete wavelength for light propagating in the third optical mode, is high;
b) a second transmission coefficient of the device at resonance, occurring at at least one second discrete wavelength for light propagating in any optical mode other than the third optical mode, is low; and
c) a third transmission coefficient of the device off resonance, for light propagating in any optical mode, is low;
wherein the first transmission coefficient is larger than the second transmission coefficient and the third transmission coefficient by at least a factor of five.

9. The optoelectronic device of claim 1, wherein each of the reflectors is selected from the group consisting of an evanescent reflector; and a multilayer interference reflector.

10. The optoelectronic device of claim 9, wherein the first optical cavity is a waveguidng cavity.

11. The optoelectronic device of claim 9, wherein the second optical cavity is a waveguiding cavity.

12. The optoelectronic device of claim 9, wherein at least one of the reflectors is a multilayered interference reflector.

13. The optoelectronic device of claim 12, wherein the first optical cavity is selected from the group consisting of a waveguiding cavity; and an antiwaveguiding cavity which localizes at least one optical mode.

14. The optoelectronic device of claim 12, wherein the second optical cavity is selected from the group consisting of a waveguiding cavity; and an antiwaveguiding cavity which localizes at least one optical mode.

15. The optoelectronic device of claim 12, wherein at least one multilayered interference reflector is a periodic structure.

16. The optoelectronic device of claim 15, wherein the first optical cavity is selected from the group consisting of:
i) a waveguiding cavity;
ii) an antiwaveguiding cavity which localizes at least one optical mode; and
iii) an optical defect formed by a deviation of a periodic structure of at least one multilayered interference reflector.

17. The optoelectronic device of claim 15, wherein the second optical cavity is selected from the group consisting of:
i) a waveguiding cavity;
ii) an antiwaveguiding cavity which localizes at least one optical mode; and
iii) an optical defect formed by a deviation from a periodic structure of at least one multilayered interference reflector.

18. The optoelectronic device of claim 1, wherein the optoelectronic device is selected from the group consisting of:
i) a semiconductor diode laser;
ii) a semiconductor optical amplifier;
iii) a semiconductor resonant cavity photodetector;
iv) an optical switch;
v) a wavelength-tunable semiconductor diode laser;
vi) a wavelength-tunable semiconductor optical amplifier;
vii) a wavelength-tunable resonant cavity photodetector;
viii) a semicondictor intensity modulator;
ix) a stereoscopic television; and
x) a light source emitting light in a broad spectrum.

19. The optoelectronic device of claim 18, wherein the semiconductor diode laser is selected from the group consisting of:
i) a tilted cavity laser operating in an edge-emitting geometry;
ii) a tilted cavity surface emitting laser; and
iii) a vertical cavity surface emitting laser.

20. The optoelectronic device of claim 18, wherein the semiconductor optical amplifier is selected from the group consisting of:
i) a tilted cavity optical amplifier operating in an edge-emitting geometry;
ii) a tilted cavity optical amplifier operating in a surface-emitting geometry; and
iii) a vertical cavity optical amplifier.

21. The optoelectronic device of claim 18, wherein the semiconductor resonant cavity photodetector is selected from the group consisting of:
i) a tilted cavity resonant photodetector operating in an edge geometry;
ii) a tilted cavity resonant photodetector operating in a surface geometry; and
iii) a vertical cavity resonant photodetector.

22. The optoelectronic device of claim 1, wherein the non-transparent element is an absorbing element selected from the group consisting of:
i) a narrow bandgap semiconductor material having a bandgap energy lower than a photon energy corresponding to a resonant wavelength of light;
ii) a quantum insertion comprising at least one quantum well, an absorption edge of which is at an energy below the photon energy corresponding to the resonant wavelength of light;
iii) a quantum insertion comprising at least one layer of quantum wires, an absorption edge of which is at an energy below the photon energy corresponding to the resonant wavelength of light;
iv) a quantum insertion comprising at least one layer of quantum dots, wherein the photon energy corresponding to the resonant wavelength of light fits within an absorption spectrum of quantum dots;
v) a heavily doped semiconductor layer;
vi) at least one semiconductor layer with a high defect density; and
vii) any combination of i) through vi).

23. The optoelectronic device of claim 22, wherein the non-transparent element is an absorbing element formed of a heavily p-doped semiconductor layer.

24. The optoelectronic device of claim 22, wherein the absorbing element comprising at least one semiconductor layer with a high defect density is selected from the group consisting of:
i) a metamorphic layer obtained via lattice-mismatched growth and containing a high density of extended or point defects;
ii) a layer containing a plurality of dislocated quantum dots;
iii) a layer containing a plurality of dislocated quantum wires;
iv) a layer grown at a low temperature;
v) a layer containing a plurality of metallic precipitates; and
vi) any combination of i) through v).

25. The optoelectronic device of claim 1, wherein the non-transparent element is a scattering element selected from the group consisting of a layer containing a high precipitate density; and a layer containing a high density of metal insertions.

26. The optoelectronic device of claim 1, wherein the non-transparent element is a reflecting element, selected from the group consisting of:
i) a metal layer;
ii) a multilayer interference reflector; and
iii) a distributed Bragg reflector.

27. The optoelectronic device of claim 1, further comprising a third optical cavity located within the second reflector, wherein the second reflector is a complex structure comprising:
a) a fourth reflector located between the first optical cavity and the third optical cavity;
b) the third optical cavity located on a side of the fourth reflector remote from the first optical cavity; and
c) a fifth reflector located on a side of the third optical cavity remote from the fourth reflector.

28. The optoelectronic device of claim 27, wherein the third optical cavity localizes at least one optical mode, wherein:
a) a fifth optical mode, localized in the third optical cavity, decays away from the third optical cavity in the fourth reflector and in the fifth reflector; and
b) an effective third angle of propagation of the fifth optical mode follows, as a function of the wavelength, a third dispersion law; and
c) all three optical cavities are at resonance; wherein resonance occurs at at least one discrete wavelength of light; wherein:
i) the effective first angle of propagation of the first optical mode matches with the effective second angle of propagation of the second optical mode and with the effective angle of propagation of the third optical mode;
ii) optical eigenmodes of the device comprise:
A) a sixth optical mode, which is a first linear combination of the first optical mode, the second optical mode and the fifth optical mode, extended over all three optical cavities;
B) a seventh optical mode, which is a second linear combination of the first optical mode, the second optical mode and the fifth optical mode, extended over all three optical cavities; and
C) an eighth optical optical mode, which is a third linear combination of the first optical mode, the second optical mode and the fifth optical mode, extended over all three optical cavities;
such that the second linear combination is different from the first linear combination, the third linear combination is different from the first linear combination, and the third linear combination is different from the second linear combination; and
iii) the sixth optical mode has a zero intensity at a node located within the third optical cavity.

29. The optoelectronic device of claim 28, wherein the non-transparent element is located at a position selected from the group consisting of:
i) a position within the fourth reflector;
ii) a position within the third optical cavity;
iii) a position within the fifth reflector; and
iv) any combination of positions i) through iii), when the non-transparent element is a complex structure;
such that:
i) a position of the node of the sixth optical mode matches with a position of the non-transparent element at at least one discrete wavelength of light;
ii) the position of the node of the sixth optical mode differs from the position of the non-transparent element at the wavelengths of light off resonance;
iii) the system at resonance occurring at at least one discrete wavelength of light is transparent to the sixth optical mode;
iv) the system at resonance occurring at at least one discrete wavelength of light is not transparent to the optical modes different from the sixth optical mode; and
v) the system off resonance occurring at at least one discrete wavelength of light is not transparent to all optical modes.

30. The optoelectronic device of claim 29, wherein the at least one discrete wavelength is one discrete wavelength.

31. The optoelectronic device of claim 29, wherein the at least one discrete wavelength is a few discrete wavelengths.

32. The optoelectronic device of claim 29, wherein the first effective angle matches with the third effective angle at a broad interval of wavelengths; and the second effective angle matches with the first effective angle and the third effective angle only at at least one discrete wavelength.

33. The optoelectronic device of claim 29, wherein the second effective angle matches with the third effective angle at a broad interval of wavelengths; and the first effective angle matches with the second effective angle and the third effective angle only at at least one discrete wavelength.

34. The optoelectronic device of claim 1, wherein the device is a semiconductor diode laser further comprising:
i) an active element comprising an active layer that emits light when exposed to an injection current when a forward bias is applied; and
ii) a substrate located at a side of the first reflector remote from the first optical cavity.

35. The optoelectronic device of claim 34, further comprising:
i) an n-contact mounted on the substrate on a side remote from the first reflector;
ii) a p-contact located on a side of the third reflector remote from the second optical cavity; and
iii) an active element bias control device located between the n-contact and the p-contact such that current can be injected into the active layer to generate light.

36. The optoelectronic device of claim 35, wherein the active element is located at a position selected from the group consisting of a position within the first optical cavity and a position within the second optical cavity.

37. The optoelectronic device of claim 35, wherein the laser is a tilted cavity surface emitting laser, further comprising an output optical aperture formed at the top contact.

38. The optoelectronic device of claim 37, wherein the output optical aperture is made such that a far field pattern of emitted laser light is single-lobe.

39. The optoelectronic device of claim 37, wherein the output optical aperture is made such that a far field pattern of emitted laser light is multi-lobe.

40. The optoelectronic device of claim 1, wherein the optoelectronic device is a semiconductor optical amplifier, further comprising:
i) an active element comprising an active layer that amplifies light when exposed to an injection current when a forward bias is applied; and
ii) a substrate located on a side of the first reflector remote from the first optical cavity.

41. The optoelectronic device of claim 40 further comprising
i) an n-contact mounted on the substrate on a side remote from the first reflector;
ii) a p-contact located on a side of the third reflector remote from the second optical cavity; and
iii) an active element bias control device located between the n-contact and the p-contact such that current can be injected into the active layer to generate light.

42. The optoelectronic device of claim 41, wherein the active element is located at a position selected from the group consisting of a position within the first optical cavity and a position within the second optical cavity.

43. The optoelectronic device of claim 1, wherein the optoelectronic device is a resonant cavity photodetector, further comprising:
i) a p-n junction element that generates photocurrent when incoming light is absorbed under an applied reverse or zero bias; and
ii) a substrate located on a side of the first reflector remote from the first optical cavity.

44. The optoelectronic device of claim 43 further comprising:
i) an n-contact mounted on the substrate on a side remote from the first reflector;
ii) a p-contact located on a side of the third reflector remote from the second optical cavity;
iii) a p-n junction element bias control device between the n-contact and the p-contact such that an electric field in the p-n junction separates photogenerated electrons and holes generating photocurrent.

45. The optoelectronic device of claim 44, wherein the p-n junction element is located at a position selected from the group consisting of a position within the first optical cavity and a position within the second optical cavity.

46. The optoelectronic device of claim 1, wherein the optoelectronic device is a vertical cavity surface emitting laser, wherein all transverse modes but one have wavelengths out of a transmission region of the interference filter, and wherein the vertical cavity surface emitting laser operates in a single-mode regime.

47. The optoelectronic device of claim 1, wherein the optoelectronic device is a tilted cavity surface emitting laser, wherein all transverse modes but one have wavelengths out of a transmission region of the interference filter, and wherein the tilted cavity surface emitting laser operates in a single-mode regime.

48. The optoelectronic device of claim 1, wherein the optoelectronic device is a wavelength-tunable semiconductor diode laser selected from the group consisting of:
a) a wavelength-tunable vertical cavity surface emitting laser;
b) a wavelength-tunable tilted cavity surface emitting laser; and
c) a wavelength-tunable tilted cavity laser operating in an edge-emitting geometry.

49. The optoelectronic device of claim 48, further comprising:
a) an active element comprising an active layer that emits light when exposed to an injection current when a forward bias is applied; and
b) a modulating element comprising a modulating layer that changes its refractive index when an electric field is applied.

50. The optoelectronic device of claim 49, wherein a refractive index of the modulating layer is changed due to a Quantum Confined Stark Effect upon an applied electric field.

51. The optoelectronic device of claim 49, wherein a refractive index of a modulating layer is changed due to a bleaching effect, which occurs due to an injection of a current when a forward bias is applied to the modulating element.

52. The optoelectronic device of claim 49, further comprising a substrate located on a side of the first reflector remote from the first optical cavity.

53. The optoelectronic device of claim 52, further comprising:
a) a first n-contact mounted on a side of the substrate remote from the first reflector;
b) an intracavity p-contact located on a side of the first optical cavity remote from the first reflector; and
c) a second n-contact located on a side of the second optical cavity remote from the second reflector.

54. The optoelectronic device of claim 53, wherein:
a) the active element is located within the first optical cavity; and
b) the modulating element is located within the second optical cavity.

55. The optoelectronic device of claim 54, further comprising:
a) an active element bias control device located between the first n-contact and the intracavity p-contact such that current can be injected into the active layer to generate light.
b) a modulating element bias control device between the intracavity p-contact and the second n-contact such that a refractive index of the modulating layer can be varied.

56. The optoelectronic device of claim 53, wherein:
a) the active element is located within the second optical cavity; and
b) the modulating element is located within the first optical cavity.

57. The optoelectronic device of claim 56, further comprising:
a) an active element bias control device between the second n-contact and the intracavity p-contact such that current can be injected into the active layer to generate light; and
b) a modulating element bias control device between the intracavity p-contact and the first n-contact such that a refractive index of the modulating layer can be varied.

58. The optoelectronic device of claim 1, wherein the optoelectronic device is a wavelength-tunable resonant optical amplifier selected from the group consisting of:
a) a wavelength-tunable vertical cavity resonant optical amplifier;
b) a wavelength-tunable tilted cavity resonant optical amplifier operating in a surface-emitting geometry; and
c) a wavelength-tunable tilted cavity resonant optical amplifier operating in an edge-emitting geometry.

59. The optoelectronic device of claim 58, further comprising:
a) an active element comprising an active layer that amplifies light when exposed to an injection current when a forward bias is applied; and
b) a modulating element comprising a modulating layer that changes its refractive index when an electric field is applied.

60. The optoelectronic device of claim 59, wherein a refractive index of a modulating layer is changed due to a Quantum Confined Stark Effect upon an applied electric field.

61. The optoelectronic device of claim 59, wherein a refractive index of a modulating layer is changed due to a bleaching effect, which occurs due to an injection of a current when a forward bias is applied to the modulating element.

62. The optoelectronic device of claim 59, further comprising a substrate located on a side of the first reflector remote from the first optical cavity.

63. The optoelectronic device of claim 62, further comprising:
a) a first n-contact mounted on a side of the substrate remote from the first reflector;
b) an intracavity p-contact located on a side of the first optical cavity remote from the first reflector; and
c) a second n-contact located on a side of the second optical cavity remote from the second reflector.

64. The optoelectronic device of claim 63, wherein:
a) the active element is located within the first optical cavity; and
b) the modulating element is located within the second optical cavity.

65. The optoelectronic device of claim 64, further comprising:
a) an active element bias control device between the first n-contact and the intracavity p-contact such that current can be injected into the active layer to generate light; and
b) a modulating element bias control device between the intracavity p-contact and the second n-contact such that a refractive index of the modulating layer can be varied.

66. The optoelectronic device of claim 63, wherein:
a) the active element is located within the second optical cavity; and
b) the modulating element is located within the first optical cavity.

67. The optoelectronic device of claim 66, further comprising:
a) an active element bias control device between the second n-contact and the intracavity p-contact such that current can be injected into the active layer to generate light; and
b) a modulating element bias control device between the intracavity p-contact and the first n-contact such that a refractive index of the modulating layer can be varied.

68. The optoelectronic device of claim 1, wherein the optoelectronic device is a wavelength-tunable resonant cavity photodetector selected from the group consisting of:
a) a wavelength-tunable vertical cavity resonant photodetector;
b) a wavelength-tunable tilted cavity resonant photodetector operating in a surface geometry; and
c) a wavelength-tunable tilted cavity resonant photodetector operating in an edge geometry.

69. The optoelectronic device of claim 68, further comprising:
a) a p-n junction element generating a photocurrent when incoming light is absorbed, under an applied reverse or zero bias; and
b) a modulating element comprising a modulating layer that changes its refractive index when an electric field is applied.

70. The optoelectronic device of claim 69, wherein a refractive index of the modulating layer is changed due to a Quantum Confined Stark Effect upon an applied electric field.

71. The optoelectronic device of claim 69, wherein the refractive index of the modulating layer is changed due to a bleaching effect, which occurs due to an injection of a current when a forward bias is applied to the modulating element.

72. The optoelectronic device of claim 69, further comprising a substrate located on a side of the first reflector remote from the first optical cavity.

73. The optoelectronic device of claim 72, further comprising:
a) a first n-contact mounted on a side of the substrate remote from the first reflector;
b) an intracavity p-contact located on a side of the first optical cavity remote from the first reflector; and
c) a second n-contact located on a side of the second optical cavity remote from the second reflector.

74. The optoelectronic device of claim 73, wherein:
a) the p-n junction element is located within the first optical cavity; and
b) the modulating element is located within the second optical cavity.

75. The optoelectronic device of claim 74, further comprising:
a) a p-n junction element bias control device between the first n-contact and the intracavity p-contact such that an electric field in the p-n junction separates photogenerated electrons and holes generating photocurrent; and
b) a modulating element bias control device between the intracavity p-contact and the second n-contact such that a refractive index of the modulating layer can be varied.

76. The optoelectronic device of claim 73, wherein:
a) the p-n junction element is located within the second optical cavity; and
b) the modulating element is located within the first optical cavity.

77. The optoelectronic device of claim 76, further comprising:
a) a p-n junction element bias control device between the second n-contact and the intracavity p-contact such that an electric field in the p-n junction separates photogenerated electrons and holes generating photocurrent; and
b) a modulating element bias control device between the intracavity p-contact and the first n-contact such that a refractive index of the modulating layer can be varied.

78. The optoelectronic device of claim 1, wherein the optoelectronic device is an intensity modulator, wherein:
i) the first reflector is a first multilayer interference reflector;
ii) the second reflector is a second multilayer interference reflector;
iii) the third reflector is a third multilayer interference reflector; and
wherein the intensity modulator further comprises:
a) a substrate located on a side of the first reflector remote from the first optical cavity;
b) a third optical cavity located on a side of the third reflector remote from the second optical cavity; and
c) a fourth reflector located on a side of the third optical cavity remote from the third reflector, wherein the fourth reflector is a multilayer interference reflector;
wherein a finesse of the third optical cavity is smaller by at least a factor of five than a finesse of the first optical cavity and a finesse of the second optical cavity; and
wherein the finesse of the cavities is defined for a propagation angle of the resonant optical mode, for which the device is transparent at resonance occurring at at least one discrete wavelength.

79. The optoelectronic device of claim 78, further comprising:
a) an active element comprising an active layer that emits light when exposed to an injection current when a forward bias is applied; wherein the active layer is located at a position selected from the group consisting of a position within the first optical cavity and a position within the second optical cavity; and
b) a modulating element located within the third optical cavity comprising a modulator layer which changes its refractive index when an electric field is applied.

80. The optoelectronic device of claim 79, further comprising:
a) a first n-contact mounted on a side of the substrate remote from the first reflector;
b) an intracavity p-contact located between the active element and the modulator element; and
c) a second n-contact located on a side of the modulating element remote from the third reflector.

81. The optoelectronic device of claim 80, further comprising:
a) an active element bias control device between the first n-contact and the intracavity p-contact such that the current can be injected into the active layer to generate light; and
b) a modulating element bias control device between the intracavity p-contact and the second n-contact such that a refractive index of the modulator layer can be varied.

82. An optoelectronic device comprising an interference filter, wherein the interference filter comprises:
a) a first reflector;
b) a second reflector;
c) a first optical cavity located between the first reflector and the second reflector;
d) a second optical cavity located on a side of the second reflector remote from the first optical cavity;
e) a third reflector located on a side of the second optical cavity remote from the second reflector;
f) a third optical cavity located on a side of the second reflector remote from the first optical cavity and on a side of the second optical cavity remote from the third reflector; and
g) a fourth reflector located between the second optical cavity and the third optical cavity;
wherein the first optical cavity localizes at least one optical mode, such that:
i) a first optical mode localized by the first optical cavity decays away from the first optical cavity to the first reflector and the second reflector;
ii) the first optical mode has a first effective angle of propagation; and
iii) the first angle of propagation as a function of the wavelength follows a first dispersion law;
wherein the second optical cavity localizes at least one optical mode, such that:
i) a second optical mode localized by the second optical cavity decays away from the second optical cavity to the third reflector and the fourth reflector;
ii) the second optical mode has a second effective angle of propagation; and
iii) the second effective angle of propagation as a function of the wavelength follows a second dispersion law;
wherein the third optical cavity localizes at least one optical mode, such that:
i) a third optical mode localized by the third optical cavity decays away from the third optical cavity to the second reflector and the fourth reflector;
ii) the third optical mode has a third effective angle of propagation; and
iii) the third angle of propagation as a function of the wavelength follows a third dispersion law;
wherein the second effective angle matches with the first effective angle in a broad interval of wavelengths;
wherein the third dispersion law is different from the first dispersion law;
wherein all three cavities are at resonance, wherein the resonance occurs at at least one discrete wavelength; and wherein:
i) the first effective angle of propagation of the first optical mode matches with the second effective angle of propagation of the second optical mode and with the third effective angle of propagation of the third optical mode; and
ii) optical eigenmodes of the device comprise:
A) a fourth optical mode, which is a first linear combination of the first optical mode, the second optical mode and the fifth optical mode, and is extended over all three optical cavities;
B) a fifth optical mode, which is a second linear combination of the first optical mode, the second optical mode and the fifth optical mode, and is extended over all three optical cavities; and
C) a sixth optical mode, which is a third linear combination of the first optical mode, the second optical mode and the fifth optical mode, and is extended over all three optical cavities;
wherein the second linear combination is different from the first linear combination;
wherein the third linear combination is different from the first linear combination; and
wherein the third linear combination is different from the second linear combination;
wherein the fourth optical mode has a zero intensity at a node located within the third optical cavity.

83. The optoelectronic device of claim 82, further comprising a non-transparent element, located at a position selected from the group consisting of:
i) a position within the second reflector;
ii) a position within the third optical cavity;
iii) a position within the fourth reflector; and
iv) any combination of positions i) through iii), when the non-transparent element is a complex structure;
such that:
i) a position of the node of the sixth optical mode matches with a position of the non-transparent element at at least one discrete wavelength of light;
ii) the position of the node of the sixth optical mode differs from the position of the non-transparent element at the wavelengths of light off resonance;
iii) the device at resonance occurring at at least one discrete wavelength of light is transparent to the sixth optical mode;
iv) the device at resonance occurring at at least one discrete wavelength of light is not transparent to the optical modes different from the sixth optical mode; and
v) the device off resonance occurring at at least one discrete wavelength of light is not transparent to all optical modes.

84. The optoelectronic device of claim 83, wherein the at least one discrete wavelength is one discrete wavelength.

85. The optoelectronic device of claim 83, wherein the at least one discrete wavelength is a few discrete wavelengths.

86. The optoelectronic device of claim 82, wherein the optoelectronic device is selected from the group consisting of:
i) a semiconductor diode laser;
ii) a semiconductor optical amplifier;
iii) a semiconductor resonant cavity photodetector;
iv) an optical switch;
v) a wavelength-tunable semiconductor diode laser;
vi) a wavelength-tunable semiconductor optical amplifier;
vii) a wavelength-tunable resonant cavity photodetector;
viii) a semicondictor intensity modulator;
ix) a stereoscopic television; and
x) a light source emitting light in a broad spectrum.

87. An optoelectronic device comprising an interference filter, wherein the interference filter comprises:
a) an odd number of cavities, wherein the odd number is at least five; and
b) at least one non-transparent element;
wherein:
i) every two neighboring cavities are separated by a reflector;
ii) a bottom reflector is placed on a side of a bottommost cavity remote from the rest of the cavities;
iii) a top reflector is placed on a side of a topmost cavity remote from the rest of the cavities;
iv) each cavity localizes at least one optical mode such that the localized optical mode decays away from the cavity in a reflector closest to the cavity from a bottom of the device and in the reflector closest to the cavity from a top of the device;
v) the optical mode localized by each cavity has an effective angle of propagation;
vi) the effective angle of propagation as a function of a wavelength of light follows a dispersion law characteristic to the cavity; and
vii) all of the cavities are at resonance which occurs at at least one discrete wavelength; wherein:
A) the effective angles of propagation of all optical modes localized by individual cavities match;
B) optical eigenmodes of the device, which extend over all cavities, are linear combinations of the optical modes localized by individual cavities; and
C) a resonant optical eigenmode has zero intensity at node positions located in every cavity having an even number, when the cavities are labeled in a series from the bottom of the device to the top of the device.

88. The optoelectronic device of claim 87, wherein the non-transparent element is located at a position selected from the group consisting of:
i) a position within a cavity having an even number, when the cavities are labeled in a series from the bottom of the device to the top of the device;
ii) a position within a reflector close to a cavity having an even number;
iii) any combination of positions i) through ii), when the non-transparent element is a complex structure;
such that:
i) the device at resonance occurring at at least one discrete wavelength is transparent to the resonant optical eigenmode having nodes at the cavities having even numbers;
ii) the device at resonance occurring at at least one discrete wavelength of light is not transparent to the optical modes different from the resonant optical eigenmode; and
iii) the device off resonance occurring at at least one discrete wavelength of light is not transparent to all optical modes.

89. The optoelectronic device of claim 88, wherein the at least one discrete wavelength is one discrete wavelength.

90. The optoelectronic device of claim 88, wherein the at least one discrete wavelength is a few discrete wavelengths.

91. The optoelectronic device of claim 88, wherein the at least one non-transparent element is one non-transparent element.

92. The optoelectronic device of claim 88, wherein the at least one non-transparent element comprises two non-transparent elements.

93. The optoelectronic device of claim 92, wherein the two non-transparent elements comprise:
i) a first non-transparent element placed at a cavity having a first even number, when cavities are labeled in a series from the bottom of the device to the top of the device; and
ii) a second non-transparent element placed at a cavity having a second even number different from the first even number.

94. The optoelectronic device of claim 87, wherein the optoelectronic device is selected from the group consisting of:
i) a semiconductor diode laser;
ii) a semiconductor optical amplifier;
iii) a semiconductor resonant cavity photodetector;
iv) an optical switch;
v) a wavelength-tunable semiconductor diode laser;
vi) a wavelength-tunable semiconductor optical amplifier;
vii) a wavelength-tunable resonant cavity photodetector;
viii) a semicondictor intensity modulator;
ix) a stereoscopic television; and
x) a light source emitting light in a broad spectrum.

95. The optoelectronic device of claim 87, wherein all cavities but one are at resonance in a broad interval of wavelengths, and the remaining cavity is at resonance with the rest of the cavities only at one or at a few selective discrete wavelengths.

96. The optoelectronic device of claim 87, wherein the optoelectronic device is an intensity modulator, further comprising:
a) an active element comprising an active layer that emits light when exposed to an injection current when a forward bias is applied; wherein the active layer is located at a position in a cavity having a first odd number, when all cavities are labeled in a series from the bottom of the device to the top of the device;
b) a modulating element further comprising a modulator layer which changes its refractive index when an electric field is applied; wherein the modulating element is located in a cavity having a second odd number different from the first odd number; and
c) a first non-transparent element located in a cavity having a first even number; and
d) a second non-transparent element located in a cavity having a second even number, different from the first even number.

97. The optoelectronic device of claim 96, further comprising:
a) an active element bias control device located between the first n-contact and the intracavity p-contact such that current can be injected into the active layer to generate light;
b) a modulating element bias control device between the intracavity p-contact and the second n-contact such that a refractive index of the modulator layer can be varied.

98. The optoelectronic device of claim 97, wherein:
a) at a first state of the modulator element set by a first value of the bias, applied by the modulating element bias control device, a refractive index of the modulator layer has a first value such that the device is transparent for a resonant optical mode at at least one discrete wavelength; and wherein the device operates as a semiconductor diode laser; and
b) at a second state of the modulator element set by a second value of the bias, applied by the modulator element bias control device, the refractive index of the modulator layer has a second value such that the device is not transparent for all optical modes at all wavelengths of light; and no laser light is emitted by the device.

99. A light source, comprising:
a) a light bulb comprising a filament that emits light in a broad spectrum when a current is applied; and
b) an interference filter covering the light bulb, wherein the filter comprises at least a first optical cavity and a second optical cavity, and a reflecting element located between the first optical cavity and the second optical cavity;
wherein the interference filter is transparent for light in a narrow interval of wavelengths; and
wherein light emitted by the filament at wavelengths off the transparency region is reflected back by the filter; and optical power is thus accumulated in the light bulb, which effectively increases a temperature of the filament;
such that a required level of the emitted optical power is obtained in a narrow interval of wavelengths by applying a smaller current to the filament.
